(19) United States
(12) Patent Application Publication
(10) Pub. No.: US 2026/0301347 A1
(43) Pub. Date: Oct. 1, 2026

(54) VEHICLE IMAGE DISPLAY SYSTEM AND VEHICLE IMAGE DISPLAY METHOD

(71) Applicant: HONDA MOTOR CO., LTD., Tokyo (JP)

(72) Inventors: Daisuke INOUE, Tokyo (JP); Shinya YASUHARA, Tokyo (JP)

(21) Appl. No.: 19/630,471

(22) Filed: Mar. 27, 2026

(30) Foreign Application Priority Data
Mar. 31, 2025 (JP) 2025-059785

(51) Int. Cl. G06T 19/20

(52) U.S. Cl. CPC G06T 19/20; G06T 2200/24; G06T 2219/2004; G06T 2219/2016

(57) ABSTRACT

A vehicle image display system including: an image data obtaining unit; and a drawing controller. The image data obtaining unit is configured to obtain three-dimensional image data of a user-designated vehicle and two-dimensional image data sets of a plurality of sub-display target vehicles from an information providing apparatus. The user-designated vehicle is designated by a user. The plurality of sub-display target vehicles is extracted from a plurality of the registered vehicles. The drawing controller is configured to cause a three-dimensional image of the user-designated vehicle to be displayed in a main image region 101a and cause two-dimensional images of the plurality of sub-display target vehicles to be displayed side by side in sub-image regions 102a defined on a wall surface 102 behind the main image region 101a on a basis of the three-dimensional image data of the user-designated vehicle and the two-dimensional image data sets of the sub-display target vehicles.

This application is based on and claims the benefit of priority from Japanese Patent Application No. 2025-059785, filed on 31 Mar. 2025, the content of which is incorporated herein by reference.

### BACKGROUND OF THE INVENTION

### Field of the Invention

The present invention relates to a vehicle image display system and a vehicle image display method. More specifically, the present invention relates to a vehicle image display system and a vehicle image display method that each cause a display screen of a user terminal to display an image of a virtual vehicle. The user terminal is operated by a user.

### Related Art

Japanese Unexamined Patent Application, Publication No. 2024-011950 discloses an invention that relates to an image display system which causes a display to display an image in which the content of customization selectable for a target vehicle is reflected on the assumption of use at the time of sales of a used vehicle. This image display system generates customized data on the basis of base model data obtained on the basis of the vehicle body number of the target vehicle and customization candidate data selectable for the target vehicle.

Patent Document 1: Japanese Unexamined Patent Application, Publication No. 2024-011950

### SUMMARY OF THE INVENTION

However, in recent years there have been requests for a technology of displaying, on a user terminal, images of a plurality of virtual vehicles customized by various users in a virtual space referred to as a metaverse. Such a technology allows a user to easily compare a vehicle customized by the user and vehicles customized by other users. It is thus possible for the user to refer to the vehicles customized by other users when customizing the vehicle of the user and communicate with other users having the same preferences.

However, when images of a plurality of vehicles created by various users are displayed on a user terminal, an excessive amount of data may be transmitted and received between a storage device that manages data regarding vehicles customized by respective users and the user terminal and the user terminal may have excessive processing load.

An object of the present invention is to provide a vehicle image display system and a vehicle image display method that each make it possible to cause a user terminal to display images of a plurality of vehicles while reducing the amount of data transmitted and received between a storage device and the user terminal and reducing the processing load on the user terminal.
(1) A vehicle image display system (e.g., a vehicle image display system 1′ described below) according to the present invention causes a display screen (e.g., a display 75a described below) of a user terminal (e.g., a user terminal 6 described below) to display an image of a virtual vehicle. The user terminal is operated by a user. The vehicle image display system includes: an image data obtaining unit (e.g., the user terminal 6, a processor 71, and an image data obtaining unit 81 described below); and a drawing controller (e.g., the user terminal 6, the processor 71, and a drawing controller 82 described below). The image data obtaining unit is configured to obtain three-dimensional image data of a user-designated vehicle and two-dimensional image data of a plurality of sub-display target vehicles from a storage device (e.g., an information providing apparatus 2, a storage 34, and a database 34c described below) that stores information about a plurality of registered vehicles including the user-designated vehicle. The user-designated vehicle is designated by the user. The plurality of sub-display target vehicles is extracted from a plurality of the registered vehicles. The drawing controller is configured to cause a three-dimensional image of the user-designated vehicle to be displayed in a main image region (e.g., main image regions 101a and 107a described below) defined in the display screen and cause two-dimensional images of the sub-display target vehicles to be displayed in sub-image regions (e.g., sub-image regions 102a described below) defined behind the main image region in the display screen on the basis of the three-dimensional image data of the user-designated vehicle and the two-dimensional image data of the sub-display target vehicles.
(2) In this case, it is preferable that the vehicle image display system further include a display target extractor (e.g., the information providing apparatus 2, the processor 31, and a display target extractor 42 described below) configured to extract a plurality of the sub-display target vehicles from a plurality of the registered vehicles in descending order of degrees of association from one with a highest degree of association with the user-designated vehicle.
(3) In this case, it is preferable that the drawing controller change a drawing manner of the two-dimensional images of the sub-display target vehicles in the sub-image regions on the basis of enlargement ratio information regarding an enlargement ratio of the three-dimensional image of the user-designated vehicle in the display screen, viewpoint position information regarding a viewpoint position of the three-dimensional image of the user-designated vehicle in the display screen, and orientation information regarding orientation of the three-dimensional image of the user-designated vehicle in the display screen.
(4) In this case, it is preferable that the drawing controller cause the three-dimensional image of the user-designated vehicle to be displayed in the main image region defined in a middle of the display screen in a width direction and cause the two-dimensional images of a plurality of the sub-display target vehicles to be displayed side by side in the sub-image regions extending along the width direction behind the main image region. The sub-image regions each have a band shape.
(5) In this case, it is preferable that the drawing controller cause the two-dimensional images of a plurality of the sub-display target vehicles to be displayed side by side in the sub-image regions such that the two-dimensional images of a plurality of the sub-display target vehicles are farther away from the three-dimensional image of the user-designated vehicle in descending order of the degrees of association with the user-designated vehicle.
(6) In this case, it is preferable that, in response to a first operation being received, the drawing controller cause the display screen to display additional information about a selection vehicle selected by the first operation. The first operation is for selecting any of a plurality of the sub-display target vehicles displayed in the sub-image regions.
(7) In this case, it is preferable that, in response to the first operation being received again with the additional information displayed on the display screen, the image data obtaining unit obtain three-dimensional image data of the selection vehicle from the storage device. The first operation is for selecting the selection vehicle. The drawing controller causes a three-dimensional image of the selection vehicle to be displayed in the main image region on the basis of the three-dimensional image data of the selection vehicle.
(8) In this case, it is preferable that, in response to a second operation being received, the image data obtaining unit obtain three-dimensional image data of a selection vehicle selected by the second operation from the storage device. The second operation is for selecting any of a plurality of the sub-display target vehicles displayed in the sub-image regions. The drawing controller causes a three-dimensional image of the selection vehicle to be displayed in the main image region on the basis of the three-dimensional image data of the selection vehicle.
(9) In this case, it is preferable that the storage device store external appearance information about the respective registered vehicles. The display target extractor calculates degrees of external appearance similarity of the respective registered vehicles to the user-designated vehicle as the degrees of association on the basis of the external appearance information and extracts the sub-display target vehicles on the basis of the degrees of association.
(10) In this case, it is preferable that the storage device store owner information about the respective registered vehicles. The display target extractor calculates degrees of personality similarity between owners of the respective registered vehicles and the user as the degrees of association on the basis of the owner information and extracts the sub-display target vehicles on the basis of the degrees of association.
(11) In this case, it is preferable that the storage device store external appearance information and owner information about the respective registered vehicles in association with each other. The display target extractor switches a first extraction algorithm and a second extraction algorithm in response to a third operation by the user. The first extraction algorithm extracts a plurality of the sub-display target vehicles in descending order of the degrees of association calculated on the basis of the external appearance information. The second extraction algorithm extracts a plurality of the sub-display target vehicles in descending order of the degrees of association calculated on the basis of the owner information.
(12) In this case, it is preferable that the storage device store external appearance information and owner information about the respective registered vehicles in association with each other. The display target extractor extracts a plurality of the sub-display target vehicles as external appearance similar vehicles in descending order of the degrees of association calculated on the basis of the external appearance information and extracts a plurality of the sub-display target vehicles as personality similar vehicles in descending order of the degrees of association calculated on the basis of the owner information. The drawing controller causes two-dimensional images of a plurality of the external appearance similar vehicles to be displayed side by side in first regions of the sub-image regions close to the three-dimensional image of the user-designated vehicle and causes two-dimensional images of a plurality of the personality similar vehicles to be displayed side by side in second regions of the sub-image regions apart from the three-dimensional image of the user-designated vehicle.
(13) In this case, it is preferable that the user terminal include the image data obtaining unit and the drawing controller. The storage device is connected to the user terminal through a network (e.g., a network N described below). The image data obtaining unit obtains the three-dimensional image data of the user-designated vehicle and the two-dimensional image data of a plurality of the sub-display target vehicles through the network.
(14) A vehicle image display method according to the present invention is a method for causing a display screen (e.g., the display 75a described below) of a user terminal (e.g., the user terminal 6 described below) to display an image of a virtual vehicle. The user terminal is operated by a user. The vehicle image display method includes: a step of obtaining, by the user terminal, three-dimensional image data of a user-designated vehicle and two-dimensional image data of a plurality of sub-display target vehicles from a storage device (e.g., the information providing apparatus 2, the storage 34, and the database 34c described below) that stores information about a plurality of registered vehicles including the user-designated vehicle; and a step of causing, by the user terminal, a three-dimensional image of the user-designated vehicle to be displayed in a main image region (e.g., the main image regions 101a and 107a described below) defined in the display screen and causing, by the user terminal, two-dimensional images of the sub-display target vehicles to be displayed in sub-image regions (e.g., the sub-image regions 102a described below) defined behind the main image region in the display screen on the basis of the three-dimensional image data of the user-designated vehicle and the two-dimensional image data of the sub-display target vehicles. The user-designated vehicle is designated by the user. The plurality of sub-display target vehicles is extracted from a plurality of the registered vehicles.
(1) An image data obtaining unit obtains three-dimensional image data of a user-designated vehicle and two-dimensional image data of a plurality of sub-display target vehicles from a storage device that stores information about a plurality of registered vehicles including the user-designated vehicle. The user-designated vehicle is designated by a user. The plurality of sub-display target vehicles is extracted from the plurality of registered vehicles. In addition, a drawing controller causes a three-dimensional image of the user-designated vehicle to be displayed in a main image region defined in a display screen of a user terminal and further causes two-dimensional images of the plurality of sub-display target vehicles to be displayed in sub-image regions defined behind the main image region in the display screen on the basis of the three-dimensional image data of the user-designated vehicle and the two-dimensional image data of the sub-display target vehicles obtained by the image data obtaining unit. This allows the user to compare the external appearance of the user-designated vehicle designated by the user with the external appearance of each of the plurality of sub-display target vehicles while viewing the external appearance of the user-designated vehicle from various angles. In this way, the present invention makes it possible to reduce the amount of data transmitted and received between the image data obtaining unit and the storage device and reduce processing load on the drawing controller by using a three-dimensional image as an image of the user-designated vehicle designated by the user and using two-dimensional images as images of the plurality of sub-display target vehicles used by the user for comparison with the user-designated vehicle.
(2) A display target extractor extracts the plurality of sub-display target vehicles in descending order of degrees of association from one with a highest degree of association with the user-designated vehicle designated by the user from the plurality of registered vehicles. This makes it possible to cause the two-dimensional images of the plurality of sub-display target vehicles each having a high degree of association with the user-designated vehicle to be displayed in the sub-image regions of the display screen of the user terminal. It is thus possible for the user to easily enjoy comparing the user-designated vehicle and the plurality of sub-display target vehicles each having a high degree of association with this user-designated vehicle.
(3) The drawing controller changes the drawing manner of the two-dimensional images of the sub-display target vehicles in the sub-image regions on the basis of enlargement ratio information, viewpoint position information, and orientation information about the three-dimensional image of the user-designated vehicle in the display screen. This makes it possible to naturally change the drawing manner of the two-dimensional images of the sub-display target vehicles depending on the enlargement ratio, the viewpoint position, the orientation, and the like of the user-designated vehicle while reducing the amount of data transmitted and received between the storage device and the image data obtaining unit.
(4) The drawing controller causes the three-dimensional image of the user-designated vehicle to be displayed in the main image region defined in the middle of the display screen in the width direction and causes the two-dimensional images of the plurality of sub-display target vehicles to be displayed side by side in the sub-image regions extending along the width direction behind the main image region. The sub-image regions each have a band shape. This allows the user to enjoy the three-dimensional image of the user-designated vehicle displayed at the position in the display screen that is most visually recognizable to the user while comparing the three-dimensional image of the user-designated vehicle with the two-dimensional images of the plurality of sub-display target vehicles displayed side by side behind the three-dimensional image of the user-designated vehicle.
(5) The drawing controller causes the two-dimensional images of the plurality of sub-display target vehicles to be displayed side by side such that the two-dimensional images of the plurality of sub-display target vehicles are farther away from the three-dimensional image of the user-designated vehicle in descending order of the degrees of association with the user-designated vehicle. This makes it possible to cause the two-dimensional images of the sub-display target vehicles each having a high degree of association with the user-designated vehicle to be displayed close to the user-designated vehicle in the display screen. This is highly convenient for the user.
(6) In response to a first operation being received, the drawing controller causes the display screen to display additional information about a selection vehicle selected by this operation. The first operation is for selecting any of the plurality of sub-display target vehicles displayed in the sub-image regions. Accordingly, the present invention allows the user to easily obtain the additional information about the selection vehicle in which the user has interest.
(7) In response to the first operation being received again with the additional information displayed on the display screen, the image data obtaining unit obtains three-dimensional image data of the same selection vehicle from the storage device. The first operation is for selecting this selection vehicle. The drawing controller causes a three-dimensional image of the selection vehicle to be displayed in the main image region on the basis of the three-dimensional image data of the selection vehicle newly obtained. Accordingly, the present invention allows the user to view the external appearance of the selection vehicle in which the user has interest in more detail by simply performing the first operation twice in succession.
(8) In response to a second operation being received, the image data obtaining unit obtains three-dimensional image data of a selection vehicle selected by this operation. The second operation is for selecting any of the plurality of sub-display target vehicles displayed in the sub-image regions. The drawing controller causes a three-dimensional image of the selection vehicle to be displayed in the main image region on the basis of the three-dimensional image data of the selection vehicle newly obtained. Accordingly, the present invention allows the user to view the external appearance of the selection vehicle in which the user has interest in more detail by simply performing the second operation.
(9) The display target extractor calculates the degrees of external appearance similarity of the respective registered vehicles to the user-designated vehicle on the basis of external appearance information about the respective registered vehicles stored in the storage device. The display target extractor extracts the plurality of sub-display target vehicles on the basis of the degrees of external appearance similarity. This allows the user to enjoy comparing the user-designated vehicle designated by the user with the plurality of sub-display target vehicles each having external appearance similar to that of this user-designated vehicle.
(10) The display target extractor calculates the degrees of personality similarity between the owners of the respective registered vehicles and the user on the basis of owner information about the respective registered vehicles stored in the storage device. The display target extractor extracts the sub-display target vehicles on the basis of the degrees of personality similarity. This allows the user to enjoy comparing the user-designated vehicle designated by the user with the sub-display target vehicles of the owners each having personality similar to that of the user.
(11) The display target extractor switches a first extraction algorithm and a second extraction algorithm in response to a third operation by the user. The first extraction algorithm extracts the sub-display target vehicles on the basis of the external appearance information. The second extraction algorithm extracts the sub-display target vehicles on the basis of the owner information. Accordingly, the present invention allows the user to change the sub-display target vehicles displayed in the sub-image regions by simply performing the third operation. This is highly convenient.
(12) The display target extractor extracts a plurality of external appearance similar vehicles from the plurality of registered vehicles on the basis of the external appearance information and extracts a plurality of personality similar vehicles from the plurality of registered vehicles on the basis of the owner information. In addition, the drawing controller causes the external appearance similar vehicles to be displayed side by side in first regions of the sub-image regions close to the user-designated vehicle and causes the personality similar vehicles to be displayed side by side in second regions of the sub-image regions apart from the user-designated vehicle. Accordingly, the present invention allows the user to enjoy comparing the user-designated vehicle designated by the user with the external appearance similar vehicles and the personality similar vehicles extracted on the basis of the respective different algorithms.
(13) The image data obtaining unit of the user terminal obtains the three-dimensional image data of the user-designated vehicle and the two-dimensional image data of the plurality of sub-display target vehicles from the storage device through the network. Accordingly, the present invention makes it possible to reduce the amount of data transmitted and received between the user terminal of each of the users and the storage device. This allows a large number of users to enjoy viewing images of vehicles at the same time.
(14) The present invention allows the user to compare the external appearance of the user-designated vehicle designated by the user with the external appearance of each of the plurality of sub-display target vehicles while viewing the external appearance of the user-designated vehicle from various angles for the same reason as that of the invention according to (1) described above. In addition, the present invention makes it possible to reduce the amount of data transmitted and received between the user terminal and the storage device and reduce the processing load on the user terminal for the same reason as that of the invention according to (1) described above.

### BRIEF DESCRIPTION OF THE DRAWINGS

FIG. 1 is a diagram illustrating configurations of a vehicle customization assistance system and a vehicle image display system according to an embodiment of the present invention;

FIG. 2A is a diagram illustrating a component that implements a main function of an information providing apparatus;

FIG. 2B is a diagram illustrating a component that implements a main function of a user terminal;

FIG. 3 is a diagram illustrating an example of a virtual vehicle exhibition space that is displayed on a display of the user terminal;

FIG. 4 is a diagram illustrating an example of a vehicle selection image that is displayed on the display by a drawing controller in initial session processing;

FIG. 5 is a diagram illustrating an example of a customization initial image;

FIG. 6 is a diagram illustrating an example of a recommendable base vehicle presentation image;

FIG. 7 is a diagram illustrating an example of a vehicle type selection image;

FIG. 8 is a diagram illustrating an example of a customization selection image;

FIG. 9 is a diagram illustrating an example of a paint method selection image; and

FIG. 10 is a diagram illustrating an example of a pattern image.

### DETAILED DESCRIPTION OF THE INVENTION

Hereinafter, a vehicle image display system and a vehicle image display method according to an embodiment of the present invention will be described with reference to the drawings.

First, wordings used in the following description will be described.

In the following embodiment, a processor having a reference sign may be one arithmetic unit or may be a combination of a plurality of arithmetic units. In addition, the processor may be an arithmetic unit of one type or may be a combination of arithmetic units of a plurality of types. Examples of the arithmetic units include a CPU (Central Processing Unit), a GPU (Graphics Processing Unit), a GPGPU (General-Purpose computing on Graphics Processing Units), an APU (Accelerated Processing Unit), a TPU (Tensor Processing Unit), or the like.

In the following embodiment, a RAM (Random Access Memory) having a reference sign is a memory that temporarily stores information and is used by the processor as a work memory.

In the following embodiment, a storage having a reference sign includes one or more non-volatile storage devices that store various programs, various parameters, and the like. Examples of the non-volatile storage devices include a flash memory (SSD (Solid State Drive)), a magnetic disk (e.g., hard disk), a magnetic tape, or the like.

In the following embodiment, a communication I/F (Interface) having a reference sign is an interface including a communication processor, an antenna, and the like. The communication I/F is in charge of communication between a plurality of computers. Examples of communication standards applied to the communication I/F include a wireless communication standard including 5G (5th Generation Mobile Communication System), Wi-Fi (R), Bluetooth (R), or the like.

In addition, the following embodiment assumes that a “user” refers to a person who uses a vehicle customization assistance system having a reference sign by operating a user terminal having a reference sign, “another user” refers to a person who is different from the user described above and uses a vehicle customization assistance system having a reference sign by operating a user terminal having no reference sign, and a “registered user” refers to a person who is registered in a database of a vehicle customization assistance system having a reference sign. Both a user and another user are thus registered users.

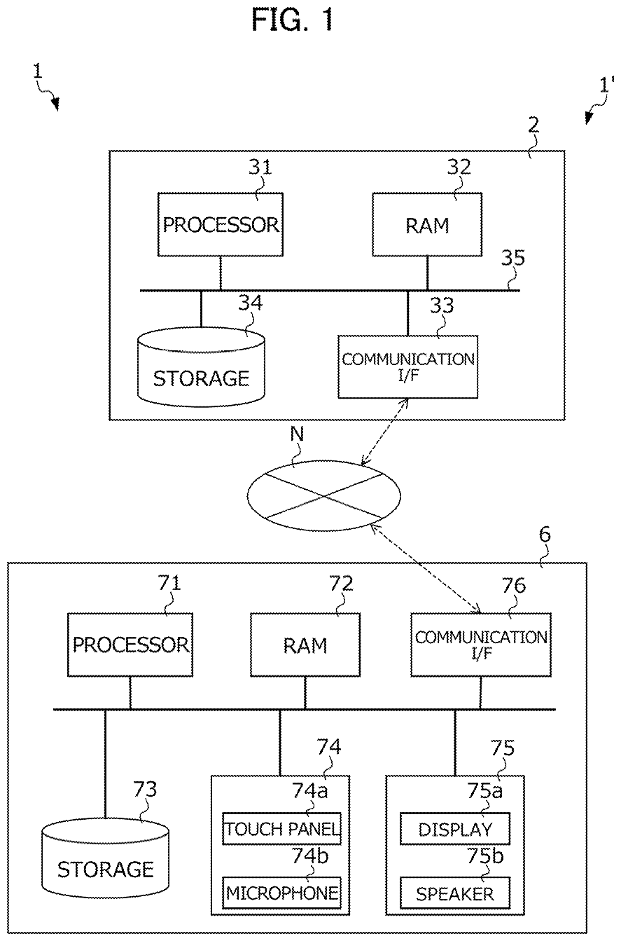

FIG. 1 is a diagram illustrating the configurations of a vehicle customization assistance system 1 and a vehicle image display system 1′ according to the present embodiment. As described below, the vehicle customization assistance system 1 has a function of causing a display screen of a user terminal operated by a user to display images of virtual vehicles customized by a large number of users in addition to a function of assisting the user operating the user terminal in customizing a virtual vehicle. The configuration of the vehicle image display system 1′ is thus the same as the configuration of the vehicle customization assistance system 1, omitting the duplicate description below.

As illustrated in FIG. 1, the vehicle customization assistance system 1 (i.e., vehicle image display system 1′) includes an information providing apparatus 2 and a user terminal 6. Examples of the information providing apparatus 2 include a server. In addition, examples of the user terminal 6 include a smartphone.

The information providing apparatus 2 is a computer including a processor 31, a RAM 32, a communication I/F 33, a storage 34, and a bus 35. The processor 31, the RAM 32, the communication I/F 33, and the storage 34 are connected to each other through the bus 35. The communication I/F 33 is connected to a network N. Examples of the network N include a WAN (Wide Area Network), a LAN (Local Area Network), and the like.

The user terminal 6 is a computer including a processor 71, a RAM 72, a storage 73, a reception device 74, an output device 75, a communication I/F 76, and a bus 77. The processor 71, the RAM 72, the storage 73, the reception device 74, the output device 75, and the communication I/F 76 are connected to each other through the bus 77.

The reception device 74 includes a touch panel 74a, a microphone 74b, and the like and receives an operation input made by a user. The touch panel 74a receives an operation input made by a user by detecting the contact of a pen, a finger, and the like of the user. The microphone 74b receives an operation input made through the voice of a user by detecting the voice of the user. The processor 71 receives operations by the user through the touch panel 74a, microphone 74b, and the like.

The output device 75 includes a display 75a, a speaker 75b, and the like and presents various kinds of information in a manner recognizable to a user using the vision, the audition, and the like. The display 75a displays information such as images and text in accordance with commands from the processor 71. The speaker 75b outputs sound in accordance with a command from the processor 71.

The communication I/F 76 is connected to the network N. That is, the information providing apparatus 2 and the user terminal 6 are connected through the network N. The communication I/F 76 of the user terminal 6 and the communication I/F 33 of the information providing apparatus 2 are in charge of the exchange of various kinds of information between the processor 71 of the user terminal 6 and the processor 31 of the information providing apparatus 2 through the network N.

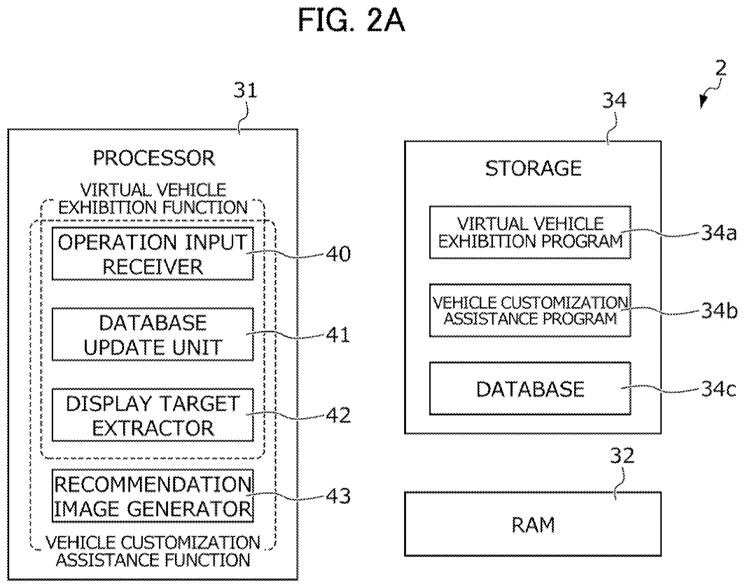

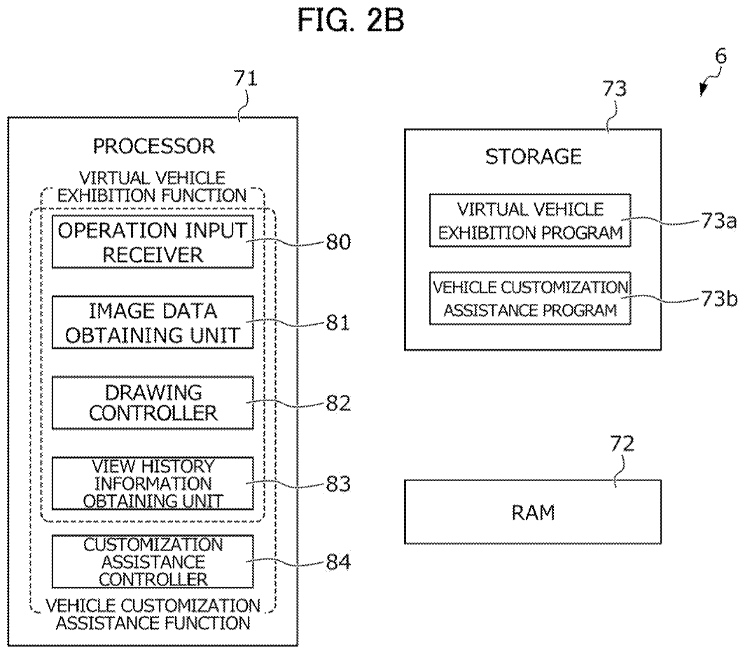

FIG. 2A is a diagram illustrating components that implement the main function of the information providing apparatus 2 and FIG. 2B is a diagram illustrating components that implement the main function of the user terminal 6. Here, the main functions of the information providing apparatus 2 and the user terminal 6 are a vehicle customization assistance function of assisting a user operating the user terminal 6 in customizing a virtual vehicle in a virtual customization room set in a virtual space and a virtual vehicle exhibition function of displaying images of vehicles customized by a large number of users using the vehicle customization assistance function described above on the display 75a of the user terminal 6 operated by the user in a virtual vehicle exhibition space set in the virtual space. That is, it is possible for a user to enjoy customizing a virtual vehicle using the vehicle customization assistance function by visiting the virtual customization room and the virtual vehicle exhibition space while operating the user terminal 6 and enjoy comparing the vehicle customized by the user using the virtual vehicle exhibition function and a vehicle customized by another user.

As illustrated in FIG. 2A, the storage 34 of the information providing apparatus 2 stores a virtual vehicle exhibition program 34a, a vehicle customization assistance program 34b, and a database 34c. The processor 31 of the information providing apparatus 2 reads the virtual vehicle exhibition program 34a from the storage 34 and executes the read virtual vehicle exhibition program 34a on the RAM 32 to implement the virtual vehicle exhibition function as described above along with the user terminal 6. In addition, the processor 31 reads the vehicle customization assistance program 34b from the storage 34 and executes the read vehicle customization assistance program 34b on the RAM 32 to implement the vehicle customization assistance function as described above along with the user terminal 6.

The processor 31 of the information providing apparatus 2 includes an operation input receiver 40, a database update unit 41, and a display target extractor 42 as functional modules that implement the virtual vehicle exhibition function on the basis of the virtual vehicle exhibition program 34a. In addition, the processor 31 includes the operation input receiver 40, the database update unit 41, the display target extractor 42, and a recommendation image generator 43 as functional modules that implement the vehicle customization assistance function on the basis of the vehicle customization assistance program 34b. The operation input receiver 40 receives various operations by a user on the user terminal 6 connected through the network N.

The database 34c stores information regarding a plurality of registered users and information regarding vehicles (also referred to as “registered vehicles” below) customized by the respective registered users using the vehicle customization assistance function in association with each other. Note that the following also refers to a registered user associated with each of the registered vehicles in the database 34c as an “owner”.

Here, the information regarding registered users includes not only owner information (e.g., a user name, age, sex, taste, a preferred vehicle type, and the like) input in advance by each registered user operating a user terminal before using the vehicle customization assistance function and the virtual vehicle exhibition function, but also information obtained afterwards such as user view history information in which the preferences of the user are reflected. The user view history information will be described below.

In addition, the information regarding registered vehicles includes external appearance information about the registered vehicle, information (also referred to as “evaluation information” below) regarding evaluations and comments from a plurality of registered users about the registered vehicle, information regarding the degree of association of the registered vehicle with another registered vehicle, the degree of similarity of the registered vehicle to another registered vehicle, and the like, and information regarding the degree of customization progress. Here, the external appearance information about a registered vehicle includes three-dimensional image data of the registered vehicle or information necessary to generate this three-dimensional image data, two-dimensional image data (the two-dimensional image data for a plurality of images will also be referred to as a “two-dimensional image data set” below) for a plurality of images obtained by viewing the registered vehicle from a plurality of different viewpoints or information necessary to generate this two-dimensional image data set, information regarding a plurality of external appearance components (e.g., a vehicle type, a wheel, a part, a vehicle body color, and the like) included in the external appearance of the registered vehicle, and text detail information regarding the plurality of external appearance components.

As illustrated in FIG. 2B, the storage 73 of the user terminal 6 stores a virtual vehicle exhibition program 73a and a vehicle customization assistance program 73b. The processor 71 of the user terminal 6 reads the virtual vehicle exhibition program 73a from the storage 73 and executes the read virtual vehicle exhibition program 73a on the RAM 72 to implement the virtual vehicle exhibition function as described above along with the information providing apparatus 2. In addition, the processor 71 reads the vehicle customization assistance program 73b from the storage 73 and executes the read vehicle customization assistance program 73b on the RAM 72 to implement the vehicle customization assistance function as described above along with the information providing apparatus 2.

The processor 71 of the user terminal 6 includes an operation input receiver 80, an image data obtaining unit 81, a drawing controller 82, and a view history information obtaining unit 83 as functional modules that implement the virtual vehicle exhibition function on the basis of the virtual vehicle exhibition program 73a. In addition, the processor 71 includes the operation input receiver 80, the image data obtaining unit 81, the drawing controller 82, the view history information obtaining unit 83, and a customization assistance controller 84 as functional modules that implement the vehicle customization assistance function on the basis of the vehicle customization assistance program 73b. The operation input receiver 80 receives various operations on the reception device 74 by a user.

Hereinafter, the functions of these respective modules of the processor 31 of the information providing apparatus 2 and the processor 71 of the user terminal 6 will be described in the order of the virtual vehicle exhibition function and the vehicle customization assistance function.

### Virtual Vehicle Exhibition Function

The processor 31 of the information providing apparatus 2 and the processor 71 of the user terminal 6 execute processing described below, triggered, for example, by a user performing an operation of entering a virtual vehicle exhibition space set in a virtual space on the user terminal 6. The processor 31 of the information providing apparatus 2 and the processor 71 of the user terminal 6 hereby implement the virtual vehicle exhibition function.

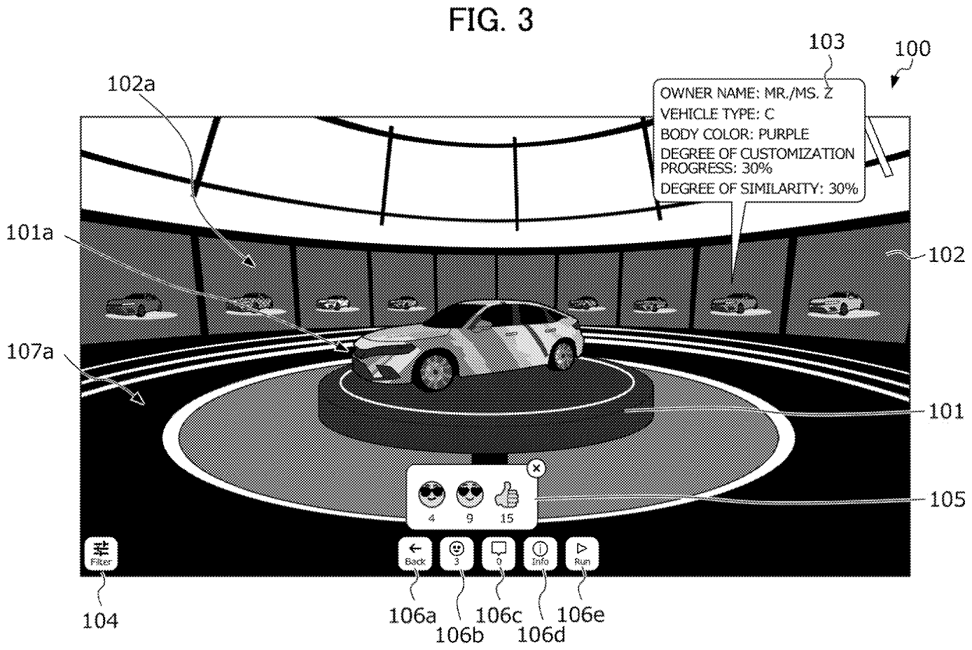

FIG. 3 is a diagram illustrating an example of a virtual vehicle exhibition space 100 that is displayed on the display 75a of the user terminal 6. An image of the virtual vehicle exhibition space as illustrated in FIG. 3 is displayed on the display 75a in a procedure described below after a user performs an operation of entering the virtual vehicle exhibition space on the user terminal 6.

As illustrated in FIG. 3, the virtual vehicle exhibition space 100 displayed on the display 75a is a substantially cylindrical space as viewed from a user and includes a disk-shaped stage 101 provided at a noticeable position in the middle thereof, an annular driving path 107, and a cylindrical wall surface 102 provided behind the stage 101 and the driving path 107 as viewed from the user to surround the stage 101 and the driving path 107. The display 75a displays the image of the virtual vehicle exhibition space 100 from a viewpoint set at a position slightly apart from the stage 101 in the middle outwardly in the radial direction in a plan view.

The stage 101 is installed in the middle of the display 75a in the width direction. The driving path 107 is installed to surround this stage 101. As illustrated in FIG. 3, an image of a vehicle (also referred to as a “user-designated vehicle” below) designated by a user from a plurality of registered vehicles is displayed on this stage 101. Additionally, although not illustrated, it is also possible to display the user-designated vehicle displayed on the stage 101 on the driving path 107 in a procedure described below. This user-designated vehicle includes, for example, a registered vehicle the owner of which is the user in the database 34c, a registered vehicle selected by the user from a plurality of vehicles displayed on the wall surface 102 in a procedure described below, a registered vehicle selected by the user in an initial session described below, and the like. All of the registered vehicles are registered vehicles in which the user have great interest. Hereinafter, regions in which the user-designated vehicle is displayed on the stage 101 and driving path 107 will also be referred to as main image regions 101a and 107a. Hereinafter, the region in which the user-designated vehicle is displayed on the stage 101 will be referred to as the first main image region 101a and the region in which the user-designated vehicle is displayed on the driving path 107 will be referred to as the second main image region 107a. In this way, the main image regions 101a and 107a in which images of the user-designated vehicle in which a user has great interest are displayed are defined at the most noticeable positions in the display 75a. In particular, the first main image region 101a is defined in the middle of the display 75a in the width direction.

The wall surface 102 has a band shape extending along the width direction behind the main image regions 101a and 107a defined on the stage 101 and the driving path 107. As illustrated in FIG. 3, the wall surface 102 extending on the display 75a in the width direction is divided into a plurality of rectangular panels by a plurality of frames extending in the longitudinal direction. FIG. 3 illustrates a case where the wall surface 102 is divided into ten panels in total, but the present invention is not limited to this. It is sufficient if the number of panels used for the wall surface 102 is two or more. In addition, respective images of a plurality of vehicles extracted from a plurality of registered vehicles through processing described below by the display target extractor 42 are displayed in the plurality of panels arranged in the band-shaped wall surface 102 along the width direction. Hereinafter, the registered vehicles extracted by the display target extractor 42 and displayed on the respective panels of the wall surface 102 will also be referred to as “sub-display target vehicles” below. A case where images of eight sub-display target vehicles in total are displayed on eight panels in total that exclude two panels behind the user-designated vehicle from ten panels in total used for the wall surface 102 will be described in FIG. 3, but the present invention is not limited to this. It is sufficient if the number of sub-display target vehicles displayed on the wall surface 102 is two or more. In addition, as illustrated in FIG. 3, the images of the respective sub-display target vehicles are smaller on the display 75a than an image of the user-designated vehicle in which a user has great interest. Hereinafter, the band-shaped regions in which the plurality of sub-display target vehicles is displayed side by side along the width direction in the wall surface 102 will also be referred to as sub-image regions 102a. In this way, the sub-image regions 102a in which the plurality of sub-display target vehicles to be compared with the user-designated vehicle is displayed have, on the display 75a, band shapes extending along the width direction behind the main image regions 101a and 107a (i.e., above the main image regions 101a and 107a on the display 75a) not to interfere with the presence of the user-designated vehicle.

An additional information display field 103 is optionally displayed (e.g., a pop-up is displayed) above the wall surface 102 in the display 75a in response to an operation by a user. Additional information (chiefly, text information) regarding a registered vehicle in which a user shows interest among a plurality of sub-display target vehicles is displayed in this additional information display field 103 as described below.

A filter icon 104 is constantly displayed at a left corner of the display 75a. It is possible for a user to switch an extraction algorithm in the display target extractor 42 described below by operating this filter icon 104. It is thus possible for the user to change a sub-display target vehicle displayed in a sub-image region by operating this filter icon 104.

An evaluation display field 105 is optionally displayed (e.g., a pop-up is displayed) slightly below the stage 101 in the display 75a in response to an operation by a user. Information regarding evaluations of the user-designated vehicle in which a user has great interest from a plurality of registered users is displayed in this evaluation display field 105 as described below. FIG. 3 illustrates a case where four registered users evaluate the user-designated vehicle as “cool”, nine registered users evaluate the user-designated vehicle as “cute”, and 15 registered users evaluate the user-designated vehicle as “recommendable”.

In addition, five function icons 106a, 106b, 106c, 106d, and 106e in total are constantly displayed in the middle of the display 75a at the lower end.

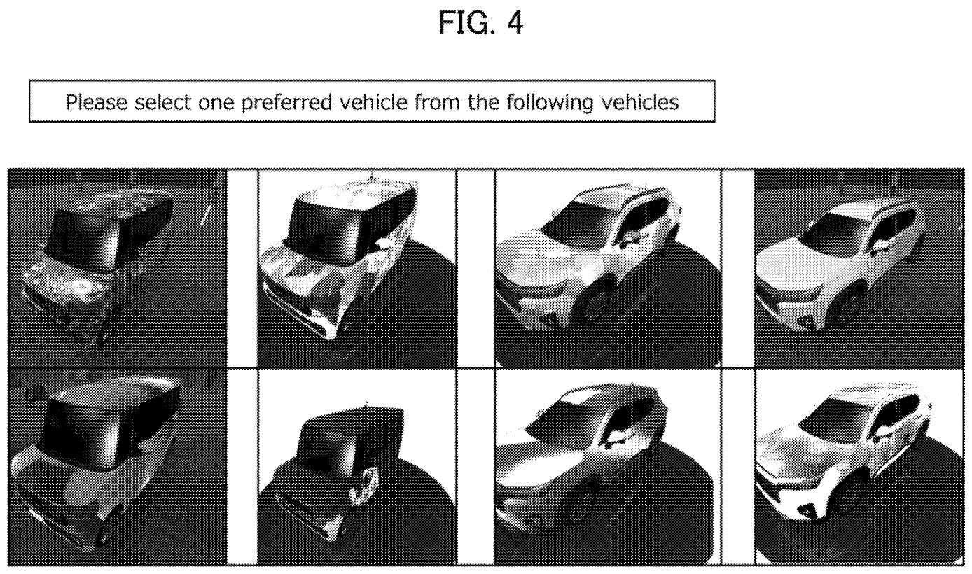

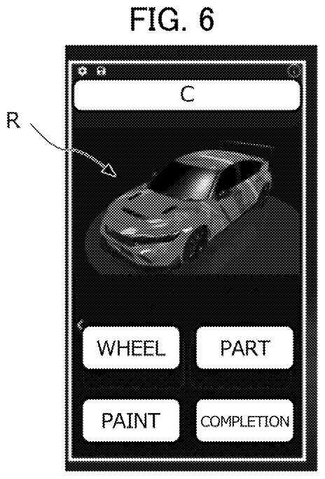

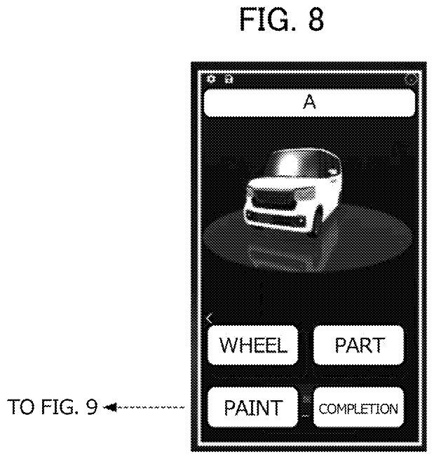

It is possible for a user to switch an image displayed on the display 75a to an image (e.g., an image for an initial session in FIG. 4 described below, a recommendable base vehicle presentation image in FIG. 6, a customization selection image in FIG. 8, and the like) before transition to the image of the virtual vehicle exhibition space 100 by operating the first function icon 106a. It is possible for the user to cause the display 75a to display a pop-up of the evaluation display field 105 described above by operating the second function icon 106b as described below. It is possible for the user to view comments of a plurality of registered users about the user-designated vehicle and input a comment about the user-designated vehicle by operating the third function icon 106c. It is possible for the user to cause the display 75a to display detail information about the user-designated vehicle by operating the fourth function icon 106d. It is possible for the user to cause the user-designated vehicle displayed in the first main image region 101a on the stage 101 to be displayed in the second main image region 107a on the driving path 107 and cause the user-designated vehicle displayed in the second main image region 107a on the driving path 107 to be displayed in the first main image region 101a on the stage as described below by operating the fifth function icon 106e.

Next, processing executed by each of the processors 31 and 71 to cause a display 75a of the user terminal 6 to display the virtual vehicle exhibition space 100 as described above is divided for description into processing at the time of entry to the virtual vehicle exhibition space 100, processing after entry to the virtual vehicle exhibition space 100, and processing before a user enters the virtual vehicle exhibition space 100 for the first time.

### Flow at Time of Entry to Virtual Vehicle Exhibition Space 100

The database update unit 41 and the display target extractor 42 included in the processor 31 of the information providing apparatus 2 execute processing described below in response to the operation input receiver 40 receiving a specific input.

First, the display target extractor 42 of the processor 31 identifies a user-designated vehicle to be displayed in the main image regions 101a and 107a of the display 75a from a plurality of registered vehicles stored in the database 34c and extracts a plurality of (eight in the example of FIG. 3) sub-display target vehicles to be displayed in the sub-image regions 102a of the display 75a in response to the operation input receiver 40 receiving an operation of entering the virtual vehicle exhibition space 100 on the user terminal 6.

The display target extractor 42 basically identifies a registered vehicle the owner of which is a user as a user-designated vehicle. In a case where the registered vehicle the owner of which is a user is not present in the database 34c, the display target extractor 42 identifies, as a user-designated vehicle, a registered vehicle designated from the plurality of registered vehicles recorded in the database 34c on the basis of an operation on the user terminal 6 by the user or a registered vehicle selected by the user in an initial session described below that is executed before the virtual vehicle exhibition space 100 is entered.

After identifying a user-designated vehicle as described above, the display target extractor 42 calculates the degrees of association of the respective registered vehicles with the user-designated vehicle and extracts a plurality of sub-display target vehicles from the plurality of registered vehicles in descending order from one with the highest degree of association. Note that a case where the display target extractor 42 calculates the degrees of association of the respective registered vehicles with the user-designated vehicle each time will be described below, but the present invention is not limited to this. The display target extractor 42 may calculate the degrees of association of the respective registered vehicles with the user-designated vehicle in advance on the basis of information stored in the database 34c and store the degrees of association in the database 34c before the user enters the virtual vehicle exhibition space 100. This makes it possible to reduce the time necessary for the display target extractor 42 to extract a plurality of sub-display target vehicles after a request is made.

Here, the display target extractor 42 extracts a plurality of sub-display target vehicles on the basis of any of four types of extraction algorithms having different procedures for calculating the degrees of association with the user-designated vehicle. In a first extraction algorithm, the display target extractor 42 calculates the degrees of external appearance similarity of the respective registered vehicles to the user-designated vehicle as the degrees of association on the basis of external appearance information stored in the database 34c and extracts sub-display target vehicles on the basis of the calculated degrees of association. It is thus possible for the display target extractor 42 to extract sub-display target vehicles each having external appearance similar to that of the user-designated vehicle from the plurality of registered vehicles stored in the database 34c by using the first extraction algorithm.

In addition, in a second extraction algorithm, the display target extractor 42 calculates the degrees of personality similarity of the owners of the respective registered vehicles to the user as the degrees of association on the basis of owner information stored in the database 34c and extracts sub-display target vehicles on the basis of the calculated degrees of association. It is thus possible for the display target extractor 42 to extract sub-display target vehicles the owner of each of which is a registered user having personality (age, sex, taste, and a preferred vehicle type) similar to that of the user from the plurality of registered vehicles stored in the database 34c by using the second extraction algorithm.

Note that the following also refers to a plurality of sub-display target vehicles extracted by the display target extractor 42 from the plurality of registered vehicles on the basis of the first extraction algorithm as “external appearance similar vehicles”. In addition, a plurality of sub-display target vehicles extracted by the display target extractor 42 from the plurality of registered vehicles on the basis of the second extraction algorithm will be referred to as “personality similar vehicles” and distinguished from the external appearance similar vehicles described above.

A third extraction algorithm is an algorithm obtained by combining the first extraction algorithm and the second extraction algorithm as described above. More specifically, in the third extraction algorithm, the display target extractor 42 extracts a plurality of external appearance similar vehicles from the plurality of registered vehicles on the basis of the first extraction algorithm and extracts a plurality of personality similar vehicles from the plurality of registered vehicles on the basis of the second extraction algorithm. It is thus possible for the display target extractor 42 to extract both external appearance similar vehicles and personality similar vehicles from the plurality of registered vehicles stored in the database 34c by using the third extraction algorithm.

In addition, in a fourth extraction algorithm, the display target extractor 42 extracts a plurality of sub-display target vehicles at random from the plurality of registered vehicles. It is thus possible for the display target extractor 42 to extract different sub-display target vehicles over and over again by using the fourth extraction algorithm.

In addition, the display target extractor 42 identifies a user-designated vehicle in the procedure as described above and further extracts a plurality of sub-display target vehicles. After that, the display target extractor 42 reads three-dimensional image data of the user-designated vehicle and two-dimensional image data sets of the plurality of respective sub-display target vehicles from the database 34c and transmits the three-dimensional image data and the two-dimensional image data sets to the user terminal 6 through the network N. In this case, it is preferable that the display target extractor 42 transmit the information regarding the degree of association calculated for each of the sub-display target vehicles, the additional information about each sub-display target vehicle, the evaluation information about the user-designated vehicle, the text detail information about the user-designated vehicle, and the like to the user terminal 6 through the network N along with the three-dimensional image data of the user-designated vehicle and the two-dimensional image data sets of the plurality of respective sub-display target vehicles as described above. Here, the additional information basically includes information stored in the database 34c such as an owner name, a vehicle type, a body color, the degree of customization progress, and the degree of similarity to the user-designated vehicle as shown in the additional information display field 103 in FIG. 3.

Meanwhile, the image data obtaining unit 81 of the processor 71 obtains information such as the three-dimensional image data of the user-designated vehicle and the two-dimensional image data sets of the plurality of respective sub-display target vehicles extracted by the display target extractor 42 from the plurality of registered vehicles from the database 34c constructed in the storage 34 included in the information providing apparatus 2 after the operation input receiver 80 receives an operation of entering the virtual vehicle exhibition space 100 on the user terminal 6. As described above, the display target extractor 42 of the processor 31 transmits the three-dimensional image data of the user-designated vehicle, the two-dimensional image data sets of the plurality of respective sub-display target vehicles, the information regarding the degree of association of each of the sub-display target vehicles with the user-designated vehicle, the additional information about each sub-display target vehicle, and the like to the user terminal 6 in response to the reception of the operation of entering the virtual vehicle exhibition space 100. The image data obtaining unit 81 therefore obtains these pieces of information transmitted from the display target extractor 42 through the network N. In addition, after obtaining the three-dimensional image data of the user-designated vehicle, the two-dimensional image data sets of the plurality of respective sub-display target vehicles, and the like from the database 34c through the network N in the procedure as described above, the image data obtaining unit 81 transmits these obtained pieces of information to the drawing controller 82.

Next, the drawing controller 82 of the processor 71 causes a three-dimensional image of the user-designated vehicle to be displayed in the first main image region 101a and further causes two-dimensional images of the plurality of sub-display target vehicles to be displayed in the sub-image regions 102a on the basis of the three-dimensional image data of the user-designated vehicle and the two-dimensional image data sets of the sub-display target vehicles transmitted from the image data obtaining unit 81 in the procedure as described above along with a background image defined in advance and images of the icons 104, 106a to 106e, and the like. More specifically, the drawing controller 82 causes the three-dimensional image of the user-designated vehicle to be displayed in the first main image region 101a defined in the middle of the display 75a in the width direction and causes the two-dimensional images of the plurality of sub-display target vehicles to be displayed side by side in the band-shaped sub-image regions 102a extending along the width direction behind this first main image region 101a in the order defined depending on the degrees of association. More specifically, the drawing controller 82 causes the two-dimensional images of the plurality of sub-display target vehicles to be displayed side by side in the sub-image regions 102a such that the two-dimensional images are farther away from the three-dimensional image of the user-designated vehicle in descending order of the degrees of association with the user-designated vehicle.

In addition, as described above, the plurality of sub-display target vehicles extracted by the display target extractor 42 on the basis of the third extraction algorithm includes both external appearance similar vehicles extracted on the basis of the first extraction algorithm and personality similar vehicles extracted on the basis of the second extraction algorithm. In such a case, it is preferable that the drawing controller 82 cause two-dimensional images of the plurality of external appearance similar vehicles to be displayed side by side in first regions (e.g., in three respective panels on the left and right from the middle in the width direction in the example illustrated in FIG. 3) of the sub-image regions 102a near the three-dimensional image of the user-designated vehicle in descending order of the degrees of association and cause two-dimensional images of the plurality of personality similar vehicles to be displayed side by side in second regions (e.g., in two respective panels on the left and right from the first regions described above in the example illustrated in FIG. 3) of the sub-image regions 102a apart from the three-dimensional image of the user-designated vehicle in descending order of the degrees of association.

This displays the image of the virtual vehicle exhibition space 100 as illustrated in FIG. 3 on the display 75a of the user terminal 6 in response to the user performing an operation of entering the virtual vehicle exhibition space 100 on the user terminal 6. In the image illustrated in FIG. 3, optional images such as the additional information display field 103 and the evaluation display field 105 are not, however, displayed basically immediately after the virtual vehicle exhibition space 100 is entered.

### Flow After Virtual Vehicle Exhibition Space 100 is Entered

After the virtual vehicle exhibition space 100 is entered in the procedure as described above, the drawing controller 82 changes an image drawing manner for the display 75a in a procedure described below in response to an operation on the user terminal 6 by the user.

First, as described above, the image of the user-designated vehicle displayed in the first main image region 101a is a three-dimensional image based on the three-dimensional image data transmitted from the database 34c. It is therefore possible for the user to enlarge the user-designated vehicle or view the user-designated vehicle from various angles by operating the user terminal 6. More specifically, in a case where the operation input receiver 80 receives an operation (e.g., a pinch-in operation, a pinch-out operation, or the like) of changing the enlargement ratio of the three-dimensional image of the user-designated vehicle on the display 75a, an operation (e.g., a swipe operation made along the longitudinal direction) of changing the viewpoint position of the three-dimensional image of the user-designated vehicle on the display 75a, an operation (e.g., a swipe operation of rotating the stage 101 made along the width direction) of changing the orientation of the user-designated vehicle on the display 75a, and the like, the drawing controller 82 changes the drawing manner of the user-designated vehicle on the stage 101 in response to these operations. In this case, the drawing controller 82 has the three-dimensional image data of the user-designated vehicle and it is thus possible for the drawing controller 82 to quickly and smoothly change the enlargement ratio, the viewpoint position, the orientation, and the like of the user-designated vehicle on the display 75a without obtaining new image data from the database 34c whenever receiving an operation as described above.

In addition, in a case where the drawing controller 82 changes the enlargement ratio, the viewpoint position, the orientation, and the like of the user-designated vehicle on the display 75a in accordance with the procedure as described above, it is preferable to accordingly switch the drawing manner of the plurality of sub-display target vehicles in the sub-image regions. More specifically, it is preferable that the drawing controller 82 obtain enlargement ratio information about the three-dimensional image of the user-designated vehicle on the display 75a, viewpoint position information about the three-dimensional image of the user-designated vehicle on the display 75a, and orientation information about the three-dimensional image of the user-designated vehicle on the display 75a on the basis of an operation received by the operation input receiver 80 and change the drawing manner of the two-dimensional images of the plurality of sub-display target vehicles on the basis of the enlargement ratio information, viewpoint position information, and orientation information. Here, as described above, the drawing controller 82 obtains, from the database 34c, two-dimensional image data sets including two-dimensional image data for a plurality of images obtained by viewing the sub-display target vehicles from a plurality of different viewpoints. It is thus preferable that the drawing controller 82 select the two-dimensional image data closest to the viewpoint position and the orientation of the three-dimensional image of the user-designated vehicle from each of the two-dimensional image data sets on the basis of the viewpoint position information and the orientation information and cause the two-dimensional image of each of the sub-display target vehicles to be displayed in the sub-image region 102a on the basis of the selected two-dimensional image data.

In addition, in a case where the operation input receiver 80 receives an operation on the fifth function icon 106e by the user, the drawing controller 82 deletes the three-dimensional image of the user-designated vehicle displayed in the first main image region 101a and causes a three-dimensional moving image of the user-designated vehicle traveling in the driving path 107 to be displayed in the second main image region 107a as described above on the basis of the three-dimensional image data of the user-designated vehicle transmitted from the display target extractor 42 through the network N. As described above, the driving path 107 has an annular shape in a plan view. Displaying the three-dimensional moving image of the user-designated vehicle traveling in the driving path 107 like this thus allows the user to enjoy viewing the user-designated vehicle from various angles. In addition, in a case where the operation input receiver 80 receives an operation on the fifth function icon 106e by the user, the drawing controller 82 deletes the three-dimensional moving image of the user-designated vehicle displayed in the second main image region 107a and causes the three-dimensional image of the user-designated vehicle to be displayed again in the first main image region 101a.

In addition, it is preferable that, in response to the operation input receiver 80 receiving a first selection operation (an operation of selecting any of the plurality of sub-display target vehicles displayed in the sub-image regions 102a by the user, for example, an operation of lightly touching an image of a sub-display target vehicle by the user) by the user, the drawing controller 82 cause additional information about the sub-display target vehicle (also referred to as a “first selection vehicle” below) selected by this first selection operation to be displayed in the additional information display field 103 defined slightly above the first selection vehicle in the display 75a. This allows the user to learn the additional information regarding the first selection vehicle in which the user has interest.

In addition, in response to the operation input receiver 40 receiving a first selection operation of selecting the first selection vehicle again with the additional information about the first selection vehicle displayed on the display 75a as described above, the display target extractor 42 of the processor 31 newly reads three-dimensional image data of the first selection vehicle selected again by this first selection operation from the database 34c and further transmits the three-dimensional image data of this first selection vehicle to the user terminal 6 through the network N. In addition, in response to the operation input receiver 80 receiving the first selection operation of selecting the first selection vehicle again with the additional information about the first selection vehicle displayed on the display 75a as described above, the image data obtaining unit 81 of the processor 71 obtains the three-dimensional image data of the first selection vehicle transmitted from the display target extractor 42 in the procedure as described above and transmits this three-dimensional image data to the drawing controller 82. In addition, the drawing controller 82 deletes the three-dimensional image of the user-designated vehicle displayed so far in the first main image region 101a on the basis of the three-dimensional image data of the first selection vehicle newly obtained by the image data obtaining unit 81 and redefines this first selection vehicle as a new user-designated vehicle and causes a three-dimensional image thereof to be displayed in the first main image region 101a.

Meanwhile, in response to the operation input receiver 40 receiving a second selection operation (an operation of selecting any of the plurality of sub-display targets displayed on the sub-image regions 102a by the user, for example, an operation of touching an image of a sub-display target vehicle by the user for a longer time than the first selection operation) by the user, the display target extractor 42 of the processor 31 newly reads three-dimensional image data of the sub-display target vehicle (also referred to as a “second selection vehicle” below) selected by this second selection operation from the database 34c and further transmits the three-dimensional image data of this second selection vehicle to the user terminal 6 through the network N. In addition, in response to the operation input receiver 80 receiving the second selection operation by the user as described above, the image data obtaining unit 81 of the processor 71 obtains the three-dimensional image data of the second selection vehicle transmitted from the display target extractor 42 in the procedure as described above and transmits this three-dimensional image data to the drawing controller 82. In addition, the drawing controller 82 deletes the three-dimensional image of the user-designated vehicle displayed so far in the first main image region 101a on the basis of the three-dimensional image data of the second selection vehicle newly obtained by the image data obtaining unit 81 and redefines this second selection vehicle as a new user-designated vehicle and causes a three-dimensional image thereof to be displayed in the first main image region 101a.

As described above, performing the first selection operation or the second selection operation of selecting any of the plurality of sub-display target vehicles displayed on the display 75a allows the user to enjoy viewing the three-dimensional image of the first selection vehicle or the second selection vehicle in which the user has interest.

In addition, the display target extractor 42 of the processor 31 changes an algorithm for extracting a plurality of sub-display target vehicles from a plurality of registered vehicles in response to the operation input receiver 40 receiving an operation on the filter icon 104 by the user and extracts a plurality of new sub-display target vehicles again. More specifically, the display target extractor 42 extracts a plurality of sub-display target vehicles again from the plurality of registered vehicles on the basis of an extraction algorithm (any of the first to fourth extraction algorithms) designated on the basis of the operation on the filter icon 104 by the user. In addition, after extracting a plurality of sub-display target vehicles again in the procedure as described above, the display target extractor 42 reads two-dimensional image data sets of the plurality of respective sub-display target vehicles newly extracted again from the database 34c and transmits the two-dimensional image data sets to the user terminal 6 through the network N. In this case, it is preferable that the display target extractor 42 transmit the information regarding the degree of association calculated for each of the sub-display target vehicles, the additional information about each sub-display target vehicle, and the like to the user terminal 6 through the network N along with the two-dimensional image data sets of the plurality of respective sub-display target vehicles as described above.

Meanwhile, the image data obtaining unit 81 of the processor 71 obtains information (such as the two-dimensional image data set of a new sub-display target vehicle) transmitted from the display target extractor 42 through the network N in the procedure as described above in response to the operation input receiver 80 receiving an operation on the filter icon 104 by the user and transmits these obtained pieces of information to the drawing controller 82. The drawing controller 82 causes two-dimensional images of the plurality of sub-display target vehicles to be displayed in the sub-image regions 102a in the same procedure as the procedure at the time of entry on the basis of the two-dimensional image data sets of the plurality of respective sub-display target vehicles transmitted from the image data obtaining unit 81 in the procedure as described above. In this way, it is possible for the user to switch an extraction algorithm in the display target extractor 42 by operating the filter icon 104 and further change a plurality of sub-display target vehicles to be displayed in the sub-image regions.

In addition, the drawing controller 82 of the processor 71 causes the display 75a to display an image (e.g., an image for an initial session in FIG. 4 described below, a recommendable base vehicle presentation image in FIG. 6, a customization selection image in FIG. 8, and the like) before transition to the image of the virtual vehicle exhibition space 100 in response to the operation input receiver 80 receiving an operation on the first function icon 106a by the user.

In addition, the drawing controller 82 of the processor 71 causes the display 75a to display a pop-up of the evaluation display field 105 as illustrated in FIG. 3 on the basis of the evaluation information about the user-designated vehicle transmitted from the display target extractor 42 through the network N as described above in response to the operation input receiver 80 receiving an operation on the second function icon 106b by the user. This allows the user to learn evaluations of the user-designated vehicle in which the user has great interest from other users.

In addition, the drawing controller 82 of the processor 71 causes the display 75a to display a comment view image for allowing the user to view comments from other users about the user-designated vehicle, a comment entry field for allowing the user to enter a comment of the user about the user-designated vehicle, and the like in response to the operation input receiver 80 receiving an operation on the third function icon 106c by the user. More specifically, the drawing controller 82 generates a comment view image on the basis of the evaluation information about the user-designated vehicle transmitted from the display target extractor 42 through the network N as described above and causes the display 75a to display the comment view image. In addition, the database update unit 41 of the processor 31 updates the evaluation information about the user-designated vehicle stored in the database 34c in response to the operation input receiver 40 receiving an input operation on the comment entry field by the user.

In addition, the drawing controller 82 of the processor 71 causes the display 75a to display a pop-up of the text detail information about the user-designated vehicle transmitted from the display target extractor 42 through the network N as described above in response to the operation input receiver 80 receiving an operation on the fourth function icon 106d by the user.

As described above, after entering the virtual vehicle exhibition space 100, it is possible for the user to change the plurality of sub-display target vehicles displayed in the sub-image regions 102a or select a vehicle in which the user has interest from the plurality of sub-display target vehicles displayed in the sub-image regions 102a. Accordingly, information regarding the history of selection operations by the user for the plurality of sub-display target vehicles displayed in the sub-image regions 102a in the virtual vehicle exhibition space 100 can be regarded as data in which the preferences of the user are reflected. Accordingly, the view history information obtaining unit 83 of the processor 71 obtains, as user view history information, the information regarding the history of selection operations by the user for a plurality of sub-display target vehicles received by the operation input receiver 80 after the virtual vehicle exhibition space 100 is entered. The view history information obtaining unit 83 transmits the user view history information obtained in the procedure as described above to the information providing apparatus 2 through the network N as appropriate. In addition, in a case where the database update unit 41 of the processor 31 obtains the user view history information transmitted from the user terminal 6 in the procedure as described above, the database update unit 41 updates the database 34c by storing this user view history information in the database 34c.

### Flow before User Enters Virtual Vehicle Exhibition Space 100 for First Time

In a case where a user enters the virtual vehicle exhibition space 100 for the first time, the processors 31 and 71 execute initial session processing described below for such a first-time user before causing the display 75a of the user terminal 6 to display the image of the virtual vehicle exhibition space 100 as illustrated in FIG. 3 in the procedure as described above. This initial session processing is processing for grasping the preferences of the first-time user. This initial session processing is executed by the processors 31 and 71, triggered by the operation input receivers 40 and 80 of the processors 31 and 71 receiving an operation of entering the virtual vehicle exhibition space 100 by a user who is a first-time user.

First, the display target extractor 42 of the processor 31 extracts, for example, a predetermined number of registered vehicles defined as at least two or more from a plurality of registered vehicles registered in the database 34c, for example, on the basis of the fourth extraction algorithm described above in response to the operation input receiver 40 receiving an operation of entering the virtual vehicle exhibition space 100 by the user who is a first-time user as described above. Note that a registered vehicle extracted by the display target extractor 42 in the initial session processing will also be referred to as a “display target vehicle” below. That is, the display target extractor 42 extracts a plurality of display target vehicles at random from the plurality of registered vehicles registered in the database 34c. In addition, after extracting a plurality of display target vehicles in the procedure as described above, the display target extractor 42 reads two-dimensional image data of the plurality of respective display target vehicles from the database 34c and transmits the two-dimensional image data to the user terminal 6 through the network N.

Meanwhile, after the operation input receiver 80 receives an operation of entering the virtual vehicle exhibition space 100 by the user who is a first-time user, the image data obtaining unit 81 of the processor 71 obtains two-dimensional image data of the plurality of display target vehicles transmitted from the display target extractor 42 of the processor 31 as described above and transmits the two-dimensional image data to the drawing controller 82. Next, the drawing controller 82 of the processor 71 causes the display 75a to display a vehicle selection image as exemplified in FIG. 4 on the basis of the two-dimensional image data of the plurality of display target vehicles transmitted from the image data obtaining unit 81.

FIG. 4 is a diagram illustrating an example of a vehicle selection image that is displayed on the display 75a by the drawing controller 82 in initial session processing. More specifically, the drawing controller 82 causes the display 75a to display side by side two-dimensional images of the plurality (eight in the example of FIG. 4) of display target vehicles extracted at random by the display target extractor 42. In addition, the drawing controller 82 displays a message “Please select one preferred vehicle from the following vehicles” as illustrated in FIG. 4 along with the two-dimensional images of the plurality of display target vehicles to prompt the user to select any of the display target vehicles. Note that a case where the number of display target vehicles presented to the user at one time is set to eight and the number of display target vehicles which the user is prompted to select at one time is only one will be described below, but the present invention is not limited this. It is sufficient if the number of display target vehicles presented to the user at one time is at least two or more and the number of display target vehicles that the user is prompted to select at one time may be two or more. It can be said that the preferences of the user are reflected in the external appearance of the vehicle selected by the user from the plurality of display target vehicles extracted at random in this way. After that, the view history information obtaining unit 83 of the processor 71 obtains, as user view history information, the information regarding the history of selection operations by the user for a plurality of display target vehicles received by the operation input receiver 80 after causing the display 75a to display the vehicle selection image described above.

The processors 31 and 71 obtain user view history information for N turns (N is any integer of 2 or more) by repeatedly performing the initial session as described above for N turns. That is, the user view history information for N turns is obtained by repeatedly extracting a plurality of display target vehicles by the display target extractor 42, presenting a plurality of display target vehicles by the drawing controller 82, performing a selection operation by the user, and obtaining user view history information by the view history information obtaining unit 83 for N turns. The view history information obtaining unit 83 transmits the user view history information for N turns obtained in the procedure as described above to the information providing apparatus 2 through the network N as appropriate. In addition, in a case where the database update unit 41 of the processor 31 obtains the user view history information for N turns transmitted from the user terminal 6 in the procedure as described above, the database update unit 41 updates the database 34c by storing this user view history information in the database 34c.

As described above, the user view history information for N turns is accumulated in the database 34c by executing the initial session processing. In addition, whenever the user selects a sub-display target vehicle displayed in a sub-image region in the virtual vehicle exhibition space 100 as described above even after the initial session processing is performed, the user view history information is accumulated in the database 34c.

In the initial session processing, the user selects at least one display target vehicle from the plurality of display target vehicles extracted on the basis of the fourth extraction algorithm. In contrast, in the virtual vehicle exhibition space 100, the user selects at least one sub-display target vehicle from the plurality of sub-display target vehicles extracted on the basis of any of the first to fourth extraction algorithms. Here, the difference is as follows: a plurality of vehicles is extracted at random from the plurality of registered vehicles in the fourth extraction algorithm; and a plurality of vehicles is extracted from the plurality of registered vehicles on the basis of the degrees of association with the user-designated vehicle in the first to third extraction algorithms. Accordingly, it is preferable that the view history information obtaining unit 83 obtain, as first user view history information, information regarding the history of selection operations for the plurality of vehicles extracted at random on the basis of the fourth extraction algorithm and obtain, as second user view history information, information regarding the history of selection operations for the plurality of vehicles extracted on the basis of the first to third extraction algorithms, thereby distinguishing and obtaining these pieces of user view history information.

### Vehicle Customization Assistance Function

The processor 31 of the information providing apparatus 2 and the processor 71 of the user terminal 6 execute processing described below, triggered, for example, by a user performing an operation of entering a vehicle customization room set in a virtual space on the user terminal 6. The processor 31 of the information providing apparatus 2 and the processor 71 of the user terminal 6 hereby implement the vehicle customization assistance function.

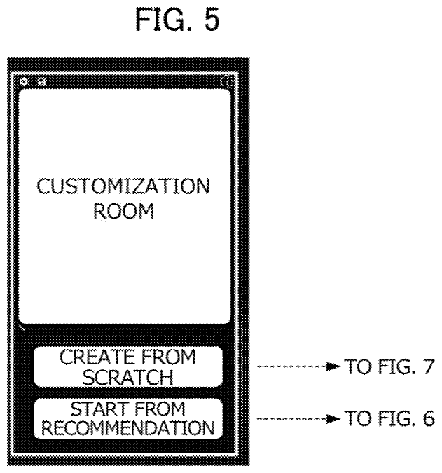

First, the customization assistance controller 84 of the processor 71 causes the display 75a to display, for example, a customization initial image as exemplified in FIG. 5 in response to the operation input receiver 80 receiving an operation of entering the vehicle customization room on the user terminal 6.

FIG. 5 is a diagram illustrating an example of the customization initial image displayed on the display 75a. The customization assistance controller 84 prompts a user to make a selection from two customization methods providable by the customization assistance controller 84 by causing the display 75a to display the customization initial image as illustrated in FIG. 5. Hereinafter, a vehicle that a user wishes to customize using the vehicle customization assistance function will also be referred to as a “customization target vehicle”. Here, “create from scratch” means that a user accomplishes customization by sequentially determining a plurality of external appearance components of the customization target vehicle basically on the basis of his or her own will. In addition, “start from recommendation” means that a user accomplishes customization on the basis of a customized vehicle automatically generated to come closer to the preferences of the user on the basis of the user view history information for the user accumulated in the database 34c as described above.

The recommendation image generator 43 of the processor 31 reads the user view history information for the user from the database 34c in response to the operation input receiver 40 receiving a selection operation on “start from recommendation” by the user. In addition, the recommendation image generator 43 identifies a plurality of registered vehicles estimated to interest the user from the plurality of registered vehicles registered in the database 34c on the basis of the user view history information read from the database 34c. Note that the registered vehicles identified by the recommendation image generator 43 on the basis of the user view history information will also be referred to as “user interest vehicles” below. In addition, the recommendation image generator 43 obtains image data, information regarding a plurality of external appearance components, and the like of the plurality of user interest vehicles identified on the basis of the user view history information from the database 34c. In addition, the recommendation image generator 43 determines all the external appearance components of the customization target vehicle by a known algorithm on the basis of the image data and the like of the plurality of user interest vehicles obtained in the procedure as described above to match the preferences of the user. In addition, the recommendation image generator 43 generates two-dimensional image data of the customization target vehicle corresponding to the respective external appearance components determined in the procedure as described above as recommendation image data and transmits the two-dimensional image data to the user terminal 6. The customization assistance controller 84 causes the display 75a to display, for example, a recommendable base vehicle presentation image as exemplified in FIG. 6 on the basis of the recommendation image data transmitted from the recommendation image generator 43 in the procedure as described above.

FIG. 6 is a diagram illustrating an example of the recommendable base vehicle presentation image displayed on the display 75a. The customization assistance controller 84 prompts the user to determine the plurality of external appearance components of the customization target vehicle by displaying a recommendation image R of the customization target vehicle in the middle of the display 75a as illustrated in FIG. 6 on the basis of the recommendation image data of the customization target vehicle transmitted from the recommendation image generator 43.

That is, the user observes the recommendation image R generated on the basis of the user view history information as illustrated in FIG. 6. If this recommendation image R matches the preferences of the user, the user operates a “completion” button provided at the lower right of the recommendable base vehicle presentation image. More specifically, the customization assistance controller 84 determines, as the plurality of external appearance components of the customization target vehicle, the same external appearance components as those of the vehicle illustrated in the recommendation image R and transmits information regarding the determined external appearance components of the customization target vehicle to the information providing apparatus 2 through the network N in response to the operation input receiver 80 receiving an operation on the “completion” button by the user. In addition, in a case where the database update unit 41 of the processor 31 obtains the information regarding the external appearance components of the customization target vehicle transmitted from the user terminal 6 in the procedure as described above, the database update unit 41 updates the database 34c by storing the information regarding the external appearance components of this customization target vehicle in the database 34c. In addition, in a case where this “completion” button is operated, it is preferable that the processors 31 and 81 set this customization target vehicle as the user-designated vehicle and start processing of entering the virtual vehicle exhibition space 100 in accordance with the procedure as described above.

In addition, the user observes the recommendation image R as illustrated in FIG. 6. In a case where this recommendation image R does not match the preferences of the user, it is possible for the user to individually determine again external appearance components that the user dislikes by operating buttons such as “wheel”, “part”, and “paint” provided below the recommendable base vehicle presentation image and a “C” button that indicates the name of the current vehicle type and is provided above the recommendable base vehicle presentation image. Note that processing executed in a case where the user operates these buttons such as “wheel”, “part”, and “paint” is qualitatively the same as processing described below with reference to FIGS. 8 to 10, omitting the detailed description thereof.

Here, as described above, the view history information obtaining unit 83 obtains, as first user view history information, information regarding the history of selection operations for the plurality of vehicles extracted at random on the basis of the fourth extraction algorithm and obtains, as second user view history information, information regarding the history of selection operations for the plurality of vehicles extracted on the basis of the first to third extraction algorithms. In general, the preference of the user is reflected more strongly in many cases in the first user view history information regarding a history of selection operations on a display target vehicle presented at random than in the second user view history information regarding a history of selection operations on a display target vehicle having a high degree of association with the user-designated vehicle. Accordingly, it is preferable that the recommendation image generator 43 generate the recommendation image data by setting a greater weight for the first user view history information than the weight of the second user view history information.

In addition, it is preferable that the recommendation image generator 43 generate the recommendation image data by excluding the information regarding the history of selection operations on a dissimilar vehicle having a degree of similarity to the user-designated vehicle lower than or equal to a predetermined threshold for the degree of similarity in the user view history information. This is because a selection operation on such a dissimilar vehicle is considered to be performed due to the operation error of the user.

As described above, the selection operation on the dissimilar vehicle is considered to be performed due to the operation error of the user in many cases. However, in a case where such a selection operation on a dissimilar vehicle is performed a plurality of times, it is considered that the user has great interest in such a dissimilar vehicle. Accordingly, in a case where the user view history information includes the information regarding the history of selection operations on the dissimilar vehicle as described above a predetermined number of times or more, it is preferable that the recommendation image generator 43 generate the recommendation image data without excluding the information regarding the history of selection operations on this dissimilar vehicle.

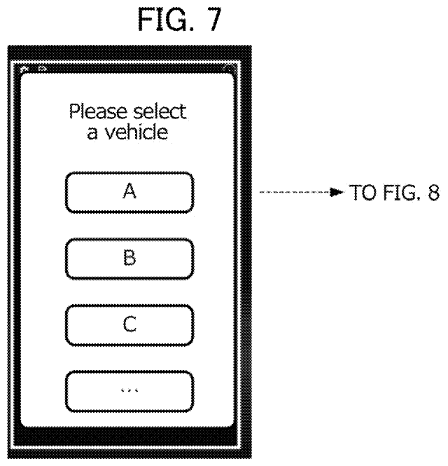

FIG. 5 will be referred to again. The customization assistance controller 84 causes the display 75a to display, for example, a vehicle type selection image as exemplified in FIG. 7 in response to the operation input receiver 80 receiving a selection operation on “create from scratch” by the user.

FIG. 7 is a diagram illustrating an example of the vehicle type selection image displayed on the display 75a. The customization assistance controller 84 prompts the user to determine a “vehicle type” that is one of the plurality of external appearance components of the customization target vehicle by causing the display 75a to display the vehicle type selection image as illustrated in FIG. 7. In the example illustrated in FIG. 7, it is possible for the user to determine any one of a vehicle type named “A”, a vehicle type named “B”, a vehicle type named “C”, and the like as the vehicle type of the customization target vehicle by operating the user terminal 6.

In response to the operation input receiver 80 receiving an operation of selecting any of the vehicle types “A”, “B”, and “C” on the vehicle type selection image as described above, the customization assistance controller 84 determines the vehicle type selected by the user as the vehicle type of the customization target vehicle and transmits information regarding the determined vehicle type of the customization target vehicle to the information providing apparatus 2 through the network N. In addition, in a case where the database update unit 41 of the processor 31 obtains the information regarding the vehicle type of the customization target vehicle transmitted from the user terminal 6 in the procedure as described above, the database update unit 41 updates the database 34c by storing the information regarding the vehicle type of this customization target vehicle in the database 34c. In addition, the customization assistance controller 84 causes the display 75a to display, for example, a customization selection image as illustrated in FIG. 8 to transition to processing of determining another external appearance component after transmitting the information regarding the vehicle type of the customization target vehicle to the information providing apparatus 2.

FIG. 8 is a diagram illustrating an example of the customization selection image displayed on the display 75a. The customization assistance controller 84 prompts the user to determine “wheel”, “part”, “paint, and the like each of which is one of the plurality of external appearance components of the customization target vehicle by causing the display 75a to display the customization selection image as illustrated in FIG. 8.

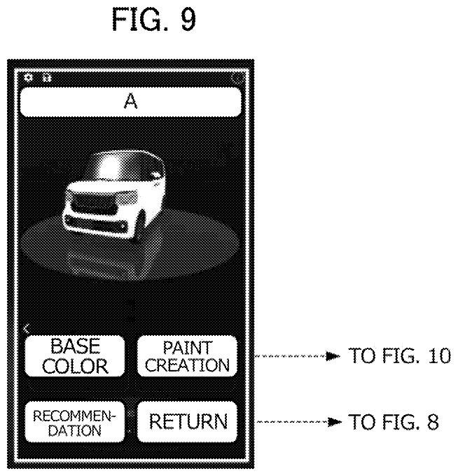

The customization assistance controller 84 causes the display 75a to display, for example, a paint method selection image as exemplified in FIG. 9 in response to the operation input receiver 80 receiving a selection operation on “paint” by the user.

FIG. 9 is a diagram illustrating an example of the paint method selection image displayed on the display 75a. The customization assistance controller 84 prompts a user to make a selection from three paint methods providable by the customization assistance controller 84 by causing the display 75a to display the paint method selection image as illustrated in FIG. 9. Here, a term “base color” means that a user accomplishes customization for a “vehicle body color” that is one of the plurality of external appearance components of the customization target vehicle by painting the respective portions included in the vehicle body in colors defined by the user. A term “paint creation” means that a user accomplishes customization for the vehicle body color by applying a pattern defined by the user to the vehicle body. A term “recommendation” means that customization is automatically accomplished for the vehicle body color of the customization target vehicle on the basis of the user view history information to come closer to the preferences of the user.

When the operation input receiver 80 receives a selection operation on “base color” by the user, the customization assistance controller 84 causes the display 75a to display a base color selection image (not illustrated). It is possible for the user to determine a color defined by the user for each of parts (e.g., the roof, the hood, the body, and the like) included in the vehicle body by performing a predetermined base color selection operation on the user terminal 6 on which this base color selection image is displayed. The customization assistance controller 84 determines the vehicle body color of the customization target vehicle in a manner selected by the user in response to the operation input receiver 80 receiving the base color selection operation by the user and transmits information regarding the determined vehicle body color of the customization target vehicle to the information providing apparatus 2 through the network N. In addition, in a case where the database update unit 41 of the processor 31 obtains the information regarding the vehicle body color of the customization target vehicle transmitted from the user terminal 6 in the procedure as described above, the database update unit 41 updates the database 34c by storing the information regarding the vehicle body color of this customization target vehicle in the database 34c.

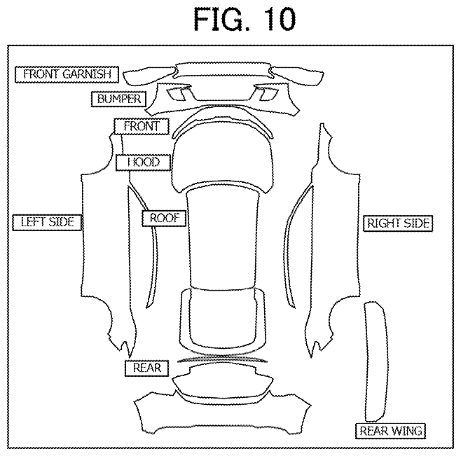

The customization assistance controller 84 causes the display 75a to display, for example, a pattern image as illustrated in FIG. 10 in a case where the operation input receiver 80 receives a selection operation on “paint creation” by the user.

FIG. 10 is a diagram illustrating an example of the pattern image displayed on the display 75a. The customization assistance controller 84 causes the display 75a to display a pattern image corresponding to the vehicle type of the customization target vehicle that has already been determined. As illustrated in FIG. 10, the pattern image is a planar development of the three-dimensional surface of the vehicle body of the customization target vehicle. It is possible for the user to apply a pattern having any color to such a pattern image by performing a paint operation made using a predetermined paint tool on the user terminal 6 on which the pattern image is displayed. The customization assistance controller 84 determines the vehicle body color of the customization target vehicle in a manner created by the user in response to the operation input receiver 80 receiving the paint operation by the user and transmits information regarding the determined vehicle body color of the customization target vehicle to the information providing apparatus 2 through the network N. In addition, in a case where the database update unit 41 of the processor 31 obtains the information regarding the vehicle body color of the customization target vehicle transmitted from the user terminal 6 in the procedure as described above, the database update unit 41 updates the database 34c by storing the information regarding the vehicle body color of this customization target vehicle in the database 34c.

FIG. 9 will be referred to again. The recommendation image generator 43 of the processor 31 reads the user view history information for the user from the database 34c in response to the operation input receiver 80 receiving a selection operation on “recommendation” by the user. In addition, the recommendation image generator 43 identifies a plurality of registered vehicles estimated to interest the user from the plurality of registered vehicles registered in the database 34c as user interest vehicles on the basis of the user view history information read from the database 34c. In addition, the recommendation image generator 43 obtains, from the database 34c, the information regarding the vehicle body color that is one of the external appearance components of each of the plurality of user interest vehicles identified on the basis of the user view history information. In addition, the recommendation image generator 43 determines the vehicle body color of the customization target vehicle by a known algorithm on the basis of the information regarding the vehicle body colors of the plurality of respective user interest vehicles obtained in the procedure as described above to match the preferences of the user. In addition, the recommendation image generator 43 generates two-dimensional image data of the customization target vehicle corresponding to the vehicle body color determined in the procedure as described above as recommendation image data and transmits the two-dimensional image data to the user terminal 6. The customization assistance controller 84 causes the recommendation image to be displayed, for example, in the middle of the paint method selection image exemplified in FIG. 9 on the basis of the recommendation image data transmitted from the recommendation image generator 43 in the procedure as described above.

The user observes the recommendation image displayed on the display 75a in the procedure as described above. If this recommendation image matches the preferences of the user, the user operates a “return” button provided at the lower right of the paint method selection image. More specifically, the customization assistance controller 84 determines, as the vehicle body color of the customization target vehicle, the same vehicle body color as that of the vehicle illustrated in the recommendation image and transmits information regarding the determined vehicle body color of the customization target vehicle to the information providing apparatus 2 through the network N in response to the operation input receiver 80 receiving an operation on the “return” button by the user. In addition, in a case where the database update unit 41 of the processor 31 obtains the information regarding the vehicle body color of the customization target vehicle transmitted from the user terminal 6 in the procedure as described above, the database update unit 41 updates the database 34c by storing the information regarding the color of this customization target vehicle in the database 34c. In addition, the customization assistance controller 84 causes the display 75a to display, for example, a customization selection image as illustrated in FIG. 8 to transition to processing of determining another external appearance component after transmitting the information regarding the vehicle body color of the customization target vehicle to the information providing apparatus 2.

Note that it is preferable that the recommendation image generator 43 generate the recommendation image data by setting a greater weight for the first user view history information than the weight of the second user view history information as with the generation of the data of the recommendation image R illustrated in FIG. 6.

In addition, it is preferable that the recommendation image generator 43 generate the recommendation image data by excluding the information regarding the history of selection operations on a dissimilar vehicle having a degree of similarity to the user-designated vehicle lower than or equal to a predetermined threshold for the degree of similarity in the user view history information as with the generation of the data of the recommendation image R illustrated in FIG. 6. In addition, in a case where the user view history information includes the information regarding the history of selection operations on the dissimilar vehicle as described above a predetermined number of times or more, it is preferable that the recommendation image generator 43 generate the recommendation image data without excluding the information regarding the history of selection operations on this dissimilar vehicle as with the generation of the data of the recommendation image R illustrated in FIG. 6.

FIG. 8 will be referred to again. In response to the operation input receiver 80 receiving a selection operation on “wheel” by the user, the customization assistance controller 84 causes the display 75a to display a wheel selection image (not illustrated). It is possible for the user to determine “wheel” that is one of the plurality of external appearance components of the customization target vehicle by performing a predetermined operation on the user terminal 6 on which this wheel selection image is displayed.

More specifically, the customization assistance controller 84 causes the display 75a to display images of a plurality of candidate wheels available for the vehicle type of the customization target vehicle that has already been determined in response to the operation input receiver 80 receiving a selection operation on “select a wheel by oneself” by the user. In addition, in response to the operation input receiver 80 receiving a wheel selection operation (e.g., an operation of selecting one candidate wheel from the plurality of candidate wheels by the user) by the user, the customization assistance controller 84 determines the candidate wheel selected by the user as a wheel of the customization target vehicle and transmits information regarding the determined wheel of the customization target vehicle to the information providing apparatus 2 through the network N. In addition, in a case where the database update unit 41 of the processor 31 obtains the information regarding the wheel of the customization target vehicle transmitted from the user terminal 6 in the procedure as described above, the database update unit 41 updates the database 34c by storing the information regarding the wheel of this customization target vehicle in the database 34c.

In addition, the recommendation image generator 43 of the processor 31 reads the user view history information for the user from the database 34c in response to the operation input receiver 80 receiving a selection operation on “recommendable wheel” by the user. In addition, the recommendation image generator 43 identifies a plurality of registered vehicles estimated to interest the user from the plurality of registered vehicles registered in the database 34c as user interest vehicles on the basis of the user view history information read from the database 34c. In addition, the recommendation image generator 43 obtains, from the database 34c, the information regarding the wheel that is one of the external appearance components of each of the plurality of user interest vehicles identified on the basis of the user view history information. In addition, the recommendation image generator 43 determines a wheel of the customization target vehicle by a known algorithm on the basis of the information regarding wheels of the plurality of respective user interest vehicles obtained in the procedure as described above to match the preferences of the user. In addition, the recommendation image generator 43 generates two-dimensional image data of the customization target vehicle corresponding to the wheel determined in the procedure as described above as recommendation image data and transmits the two-dimensional image data to the user terminal 6. The customization assistance controller 84 causes the display 75a to display the recommendation image including the image of the wheel determined to match the preferences of the user as described above on the basis of the recommendation image data transmitted from the recommendation image generator 43 in the procedure as described above. The user observes the recommendation image displayed on the display 75a in the procedure as described above. If this recommendation image matches the preferences of the user, the user performs a predetermined determination operation on the user terminal 6. The customization assistance controller 84 determines, as a wheel of the customization target vehicle, the same wheel as that of the vehicle illustrated in the recommendation image and transmits information regarding the determined wheel of the customization target vehicle to the information providing apparatus 2 through the network N in response to the operation input receiver 80 receiving a determination operation by the user. In addition, the database update unit 41 of the processor 31 updates the database 34c by storing the information regarding the wheel of the customization target vehicle transmitted from the user terminal 6 in the database 34c in the procedure as described above.

In addition, the customization assistance controller 84 causes the display 75a to display a part selection image (not illustrated) in response to the operation input receiver 80 receiving a selection operation on “part” by the user with the customization selection image as illustrated in FIG. 8 displayed. It is possible for the user to determine “part” that is one of the plurality of external appearance components of the customization target vehicle by performing a predetermined operation on the user terminal 6 on which this part selection image is displayed.

More specifically, the customization assistance controller 84 causes the display 75a to display images of a plurality of candidate parts available for the vehicle type of the customization target vehicle that has already been determined in response to the operation input receiver 80 receiving a selection operation on “select a part by oneself” by the user. In addition, in response to the operation input receiver 80 receiving a part selection operation (e.g., an operation of selecting one candidate part from the plurality of candidate parts by the user) by the user, the customization assistance controller 84 determines the candidate part selected by the user as a part of the customization target vehicle and transmits information regarding the determined part of the customization target vehicle to the information providing apparatus 2 through the network N. In addition, in a case where the database update unit 41 of the processor 31 obtains the information regarding the part of the customization target vehicle transmitted from the user terminal 6 in the procedure as described above, the database update unit 41 updates the database 34c by storing the information regarding the part of this customization target vehicle in the database 34c.

In addition, the recommendation image generator 43 of the processor 31 reads the user view history information for the user from the database 34c in response to the operation input receiver 80 receiving a selection operation on “recommendable part” by the user. In addition, the recommendation image generator 43 identifies a plurality of registered vehicles estimated to interest the user from the plurality of registered vehicles registered in the database 34c as user interest vehicles on the basis of the user view history information read from the database 34c. In addition, the recommendation image generator 43 obtains, from the database 34c, the information regarding the part that is one of the external appearance components of each of the plurality of user interest vehicles identified on the basis of the user view history information. In addition, the recommendation image generator 43 determines a part of the customization target vehicle by a known algorithm on the basis of the information regarding parts of the plurality of respective user interest vehicles obtained in the procedure as described above to match the preferences of the user. In addition, the recommendation image generator 43 generates two-dimensional image data of the customization target vehicle corresponding to the part determined in the procedure as described above as recommendation image data and transmits the two-dimensional image data to the user terminal 6. The customization assistance controller 84 causes the display 75a to display the recommendation image including the image of the part determined to match the preferences of the user as described above on the basis of the recommendation image data transmitted from the recommendation image generator 43 in the procedure as described above. The user observes the recommendation image displayed on the display 75a in the procedure as described. If this recommendation image matches the preferences of the user, the user performs a predetermined determination operation on the user terminal 6. The customization assistance controller 84 determines, as a part of the customization target vehicle, the same part as that of the vehicle illustrated in the recommendation image and transmits information regarding the determined part of the customization target vehicle to the information providing apparatus 2 through the network N in response to the operation input receiver 80 receiving a determination operation by the user. In addition, the database update unit 41 of the processor 31 updates the database 34c by storing the information regarding the part of the customization target vehicle transmitted from the user terminal 6 in the database 34c in the procedure as described above.

The vehicle image display system 1′ and the vehicle image display method according to the present embodiment attain the following advantageous effects.
(1) The image data obtaining unit 81 of the user terminal 6 obtains the three-dimensional image data of the user-designated vehicle and the two-dimensional image data sets of the plurality of sub-display target vehicles from the database 34c of the information providing apparatus 2 that stores the information about the plurality of registered vehicles including the user-designated vehicle. The user-designated vehicle is designated by a user. The plurality of sub-display target vehicles is extracted from the plurality of registered vehicles. In addition, the drawing controller 82 of the user terminal 6 causes the three-dimensional images of the user-designated vehicle to be displayed in the main image regions 101a and 107a defined in the display 75a of the user terminal 6 and further causes the two-dimensional images of the plurality of sub-display target vehicles to be displayed in sub-image regions 102a defined behind the main image regions 101a and 107a in the display 75a on the basis of the three-dimensional image data of the user-designated vehicle and the two-dimensional image data sets of the sub-display target vehicles obtained by the image data obtaining unit 81. This allows the user to compare the external appearance of the user-designated vehicle designated by the user with the external appearance of each of the plurality of sub-display target vehicles while viewing the external appearance of the user-designated vehicle from various angles. In this way, the vehicle image display system 1′ makes it possible to reduce the amount of data transmitted and received between the image data obtaining unit 81 of the user terminal 6 and the database 34c of the information providing apparatus 2 and reduce the processing load on the drawing controller 82 of the user terminal 6 by using a three-dimensional image as the image of the user-designated vehicle designated by the user and using two-dimensional images as the images of the plurality of sub-display target vehicles used by the user for comparison with the user-designated vehicle.
(2) The display target extractor 42 of the information providing apparatus 2 extracts the plurality of sub-display target vehicles in descending order of degrees of association from one with the highest degree of association with the user-designated vehicle designated by the user from the plurality of registered vehicles. This makes it possible to cause the two-dimensional images of the plurality of sub-display target vehicles each having a high degree of association with the user-designated vehicle to be displayed in the sub-image regions 102a of the display 75a of the user terminal 6. It is thus possible for the user to easily enjoy comparing the user-designated vehicle and the plurality of sub-display target vehicles each having a high degree of association with this user-designated vehicle.
(3) The drawing controller 82 of the user terminal 6 changes the drawing manner of the two-dimensional images of the sub-display target vehicles in the sub-image regions 102a on the basis of the enlargement ratio information, the viewpoint position information, and the orientation information about the three-dimensional image of the user-designated vehicle in the display 75a. This makes it possible to naturally change the drawing manner of the two-dimensional images of the sub-display target vehicles depending on the enlargement ratio, the viewpoint position, the orientation, and the like of the user-designated vehicle while reducing the amount of data transmitted and received between the information providing apparatus 2 and the user terminal 6.
(4) The drawing controller 82 of the user terminal 6 causes the three-dimensional image of the user-designated vehicle to be displayed in the first main image region 101a defined in the middle of the display 75a in the width direction and causes the two-dimensional images of the plurality of sub-display target vehicles to be displayed side by side in the sub-image regions 102a extending along the width direction behind the first main image region 101a. The sub-image regions 102a each have a band shape. This allows the user to enjoy the three-dimensional image of the user-designated vehicle displayed at the position in the display 75a that is most visually recognizable to the user while comparing the three-dimensional image of the user-designated vehicle with the two-dimensional images of the plurality of sub-display target vehicles displayed side by side behind the three-dimensional image of the user-designated vehicle.
(5) The drawing controller 82 of the user terminal 6 causes the two-dimensional images of the plurality of sub-display target vehicles to be displayed side by side such that the two-dimensional images of the plurality of sub-display target vehicles are farther away from the three-dimensional image of the user-designated vehicle in descending order of the degrees of association with the user-designated vehicle. This makes it possible to cause the two-dimensional images of the sub-display target vehicles each having a high degree of association with the user-designated vehicle to be displayed close to the user-designated vehicle in the display 75a. This is highly convenient for the user.
(6) In response to the first selection operation being received, the drawing controller 82 of the user terminal 6 causes the display screen to display additional information about a selection vehicle selected by this first selection operation. The first operation is for selecting any of the plurality of sub-display target vehicles displayed in the sub-image regions 102a. Accordingly, the vehicle image display system 1′ allows the user to easily obtain the additional information about the selection vehicle in which the user has interest.
(7) In response to the first selection operation being received again with the additional information displayed on the display 75a, the image data obtaining unit 81 of the user terminal 6 obtains the three-dimensional image data of the same selection vehicle from the database 34c of the information providing apparatus 2. The first selection operation is for selecting this selection vehicle. The drawing controller 82 causes a three-dimensional image of the selection vehicle to be displayed in the first main image region 101a on the basis of the three-dimensional image data of the selection vehicle newly obtained. Accordingly, the vehicle image display system 1′ allows the user to view the external appearance of the selection vehicle in which the user has interest in more detail by simply performing the first selection operation twice in succession.
(8) In response to a second selection operation being received, the image data obtaining unit 81 of the user terminal 6 obtains three-dimensional image data of a selection vehicle selected by this second operation. The second selection operation is for selecting any of the plurality of sub-display target vehicles displayed in the sub-image regions 102a. The drawing controller 82 causes a three-dimensional image of the selection vehicle to be displayed in the first main image region 101a on the basis of the three-dimensional image data of the selection vehicle newly obtained. Accordingly, the vehicle image display system 1′ allows the user to view the external appearance of the selection vehicle in which the user has interest in more detail by simply performing the second selection operation.
(9) The display target extractor 42 of the information providing apparatus 2 calculates the degrees of external appearance similarity of the respective registered vehicles to the user-designated vehicle on the basis of external appearance information about the respective registered vehicles stored in the database 34c. The display target extractor 42 extracts the plurality of sub-display target vehicles on the basis of the degrees of external appearance similarity. This allows the user to enjoy comparing the user-designated vehicle designated by the user with the plurality of sub-display target vehicles each having external appearance similar to that of this user-designated vehicle.
(10) The display target extractor 42 of the information providing apparatus 2 calculates the degrees of personality similarity between the owners of the respective registered vehicles and the user on the basis of owner information about the respective registered vehicles stored in the database 34c. The display target extractor 42 extracts the sub-display target vehicles on the basis of the degrees of personality similarity. This allows the user to enjoy comparing the user-designated vehicle designated by the user with the sub-display target vehicles of the owners each having personality similar to that of the user.
(11) The display target extractor 42 of the information providing apparatus 2 switches the first extraction algorithm for extracting the sub-display target vehicles on the basis of the pieces of external appearance information, the second extraction algorithm for extracting the sub-display target vehicles on the basis of the owner information, the third extraction algorithm obtained by combining the first and the second extraction algorithms, and the fourth extraction algorithm for extracting the sub-display target vehicles at random in response to an operation on the filter icon 104 by the user. Accordingly, the vehicle image display system 1′ allows the user to change the sub-display target vehicles displayed in the sub-image regions 102a by simply performing an operation on the filter icon 104. This is highly convenient.
(12) The display target extractor 42 of the information providing apparatus 2 extracts a plurality of external appearance similar vehicles from the plurality of registered vehicles on the basis of the external appearance information and extracts a plurality of personality similar vehicles from the plurality of registered vehicles on the basis of the owner information. In addition, the drawing controller 82 causes the external appearance similar vehicles to be displayed side by side in the first regions of the sub-image regions 102a close to the user-designated vehicle and causes the personality similar vehicles to be displayed side by side in the second regions of the sub-image regions 102a apart from the user-designated vehicle. Accordingly, the vehicle image display system 1′ allows the user to enjoy comparing the user-designated vehicle designated by the user with the external appearance similar vehicles and the personality similar vehicles extracted on the basis of the respective different algorithms.
(13) The image data obtaining unit 81 of the user terminal 6 obtains the three-dimensional image data of the user-designated vehicle and the two-dimensional image data sets of the plurality of sub-display target vehicles from the database 34c of the information providing apparatus 2 through the network N. Accordingly, the vehicle image display system 1′ makes it possible to reduce the amount of data transmitted and received between the user terminal of each of the users and the information providing apparatus 2. This allows a large number of users to enjoy viewing images of vehicles at the same time.
(14) The vehicle image display method according to the present embodiment allows the user to compare the external appearance of the user-designated vehicle designated by the user with the external appearance of each of the plurality of sub-display target vehicles while viewing the external appearance of the user-designated vehicle from various angles. In addition, the vehicle image display method makes it possible to reduce the amount of data transmitted and received between the user terminal 6 and the information providing apparatus 2 and reduce the processing load on the user terminal 6.

The embodiment of the present invention has been described so far, but the present invention is not limited to this. It is possible to modify the details of the configuration as appropriate within the scope of the spirits of the present invention.

What is claimed is:

1. A vehicle image display system that causes a display screen of a user terminal to display an image of a virtual vehicle, the user terminal being operated by a user, the vehicle image display system comprising:
an image data obtaining unit configured to obtain three-dimensional image data of a user-designated vehicle and two-dimensional image data of a plurality of sub-display target vehicles from a storage device that stores information about a plurality of registered vehicles including the user-designated vehicle, the user-designated vehicle being designated by the user, the plurality of sub-display target vehicles being extracted from a plurality of the registered vehicles; and
a drawing controller configured to cause a three-dimensional image of the user-designated vehicle to be displayed in a main image region defined in the display screen and cause two-dimensional images of the sub-display target vehicles to be displayed in sub-image regions defined behind the main image region in the display screen on a basis of the three-dimensional image data of the user-designated vehicle and the pieces of two-dimensional image data of the sub-display target vehicles.

2. The vehicle image display system according to claim 1, further comprising a display target extractor configured to extract a plurality of the sub-display target vehicles from a plurality of the registered vehicles in descending order of degrees of association from one with a highest degree of association with the user-designated vehicle.

3. The vehicle image display system according to claim 2, wherein the drawing controller changes a drawing manner of the two-dimensional images of the sub-display target vehicles in the sub-image regions on a basis of enlargement ratio information regarding an enlargement ratio of the three-dimensional image of the user-designated vehicle in the display screen, viewpoint position information regarding a viewpoint position of the three-dimensional image of the user-designated vehicle in the display screen, and orientation information regarding orientation of the three-dimensional image of the user-designated vehicle in the display screen.

4. The vehicle image display system according to claim 2, wherein the drawing controller causes the three-dimensional image of the user-designated vehicle to be displayed in the main image region defined in a middle of the display screen in a width direction and causes the two-dimensional images of a plurality of the sub-display target vehicles to be displayed side by side in the sub-image regions extending along the width direction behind the main image region, the sub-image regions each having a band shape.

5. The vehicle image display system according to claim 4, wherein the drawing controller causes the two-dimensional images of a plurality of the sub-display target vehicles to be displayed side by side in the sub-image regions such that the two-dimensional images of a plurality of the sub-display target vehicles are farther away from the three-dimensional image of the user-designated vehicle in descending order of the degrees of association with the user-designated vehicle.

6. The vehicle image display system according to claim 3, wherein the drawing controller causes the three-dimensional image of the user-designated vehicle to be displayed in the main image region defined in a middle of the display screen in a width direction and causes the two-dimensional images of a plurality of the sub-display target vehicles to be displayed side by side in the sub-image regions extending along the width direction behind the main image region, the sub-image regions each having a band shape.

7. The vehicle image display system according to claim 6, wherein the drawing controller causes the two-dimensional images of a plurality of the sub-display target vehicles to be displayed side by side in the sub-image regions such that the two-dimensional images of a plurality of the sub-display target vehicles are farther away from the three-dimensional image of the user-designated vehicle in descending order of the degrees of association with the user-designated vehicle.

8. The vehicle image display system according to claim 2, wherein, in response to a first operation being received, the drawing controller causes the display screen to display additional information about a selection vehicle selected by the first operation, the first operation being for selecting any of a plurality of the sub-display target vehicles displayed in the sub-image regions.

9. The vehicle image display system according to claim 8, wherein, in response to the first operation being received again with the additional information displayed on the display screen, the image data obtaining unit obtains three-dimensional image data of the selection vehicle from the storage device, the first operation being for selecting the selection vehicle, and
the drawing controller causes a three-dimensional image of the selection vehicle to be displayed in the main image region on a basis of the three-dimensional image data of the selection vehicle.

10. The vehicle image display system according to claim 3, wherein, in response to a first operation being received, the drawing controller causes the display screen to display additional information about a selection vehicle selected by the first operation, the first operation being for selecting any of a plurality of the sub-display target vehicles displayed in the sub-image regions.

11. The vehicle image display system according to claim 10, wherein, in response to the first operation being received again with the additional information displayed on the display screen, the image data obtaining unit obtains three-dimensional image data of the selection vehicle from the storage device, the first operation being for selecting the selection vehicle, and
the drawing controller causes a three-dimensional image of the selection vehicle to be displayed in the main image region on a basis of the three-dimensional image data of the selection vehicle.

12. The vehicle image display system according to claim 2, wherein, in response to a second operation being received, the image data obtaining unit obtains three-dimensional image data of a selection vehicle selected by the second operation from the storage device, the second operation being for selecting any of a plurality of the sub-display target vehicles displayed in the sub-image regions, and
the drawing controller causes a three-dimensional image of the selection vehicle to be displayed in the main image region on a basis of the three-dimensional image data of the selection vehicle.

13. The vehicle image display system according to claim 2, wherein the storage device stores external appearance information about the respective registered vehicles, and
the display target extractor calculates degrees of external appearance similarity of the respective registered vehicles to the user-designated vehicle as the degrees of association on a basis of the external appearance information and extracts the sub-display target vehicles on a basis of the degrees of association.

14. The vehicle image display system according to claim 2, wherein the storage device stores owner information about the respective registered vehicles, and
the display target extractor calculates degrees of personality similarity between owners of the respective registered vehicles and the user as the degrees of association on a basis of the owner information and extracts the sub-display target vehicles on a basis of the degrees of association.

15. The vehicle image display system according to claim 2, wherein the storage device stores external appearance information and owner information about the respective registered vehicles in association with each other, and
the display target extractor switches a first extraction algorithm and a second extraction algorithm in response to a third operation by the user, the first extraction algorithm extracting a plurality of the sub-display target vehicles in descending order of the degrees of association calculated on a basis of the external appearance information, the second extraction algorithm extracting a plurality of the sub-display target vehicles in descending order of the degrees of association calculated on a basis of the owner information.

16. The vehicle image display system according to claim 4, wherein the storage device stores external appearance information and owner information about the respective registered vehicles in association with each other, and
the display target extractor extracts a plurality of the sub-display target vehicles as external appearance similar vehicles in descending order of the degrees of association calculated on a basis of the external appearance information and extracts a plurality of the sub-display target vehicles as personality similar vehicles in descending order of the degrees of association calculated on a basis of the owner information, and
the drawing controller causes two-dimensional images of a plurality of the external appearance similar vehicles to be displayed side by side in first regions of the sub-image regions close to the three-dimensional image of the user-designated vehicle and causes two-dimensional images of a plurality of the personality similar vehicles to be displayed side by side in second regions of the sub-image regions apart from the three-dimensional image of the user-designated vehicle.

17. The vehicle image display system according to claim 1, wherein the user terminal includes the image data obtaining unit and the drawing controller,
the storage device is connected to the user terminal through a network, and
the image data obtaining unit obtains the three-dimensional image data of the user-designated vehicle and the two-dimensional image data of a plurality of the sub-display target vehicles through the network.

18. A vehicle image display method for causing a display screen of a user terminal to display an image of a virtual vehicle, the user terminal being operated by a user, the vehicle image display method comprising:
a step of obtaining, by the user terminal, three-dimensional image data of a user-designated vehicle and two-dimensional image data of a plurality of sub-display target vehicles from a storage device that stores information about a plurality of registered vehicles including the user-designated vehicle, the user-designated vehicle being designated by the user, the plurality of sub-display target vehicles being extracted from a plurality of the registered vehicles; and
a step of causing, by the user terminal, a three-dimensional image of the user-designated vehicle to be displayed in a main image region defined in the display screen and causing, by the user terminal, two-dimensional images of the sub-display target vehicles to be displayed in sub-image regions defined behind the main image region in the display screen on a basis of the three-dimensional image data of the user-designated vehicle and the two-dimensional image data of the sub-display target vehicles.
